(19) United States
(12) Patent Application Publication
(10) Pub. No.: US 2002/0015217 A1
(43) Pub. Date: Feb. 7, 2002

(54) Achromatic variable view lens

(76) Inventor: Ray Marvin Alden, Raleigh, NC (US)

Correspondence Address: Ray Marvin Alden, 808 Lake Brandon Trail, Raleigh, NC, 27610, US

(21) Appl. No.: 09/782,368

(22) Filed: Feb. 12, 2001

Related U.S. Application Data
(60) Provisional application No. 60/258,282, filed on Dec. 26, 2000.
(60) Provisional application No. 60/259,363, filed on Jan. 2, 2001.
(60) Provisional application No. 60/149,059, filed on Aug. 16, 1999.
(60) Provisional application No. 60/162,988, filed on Nov. 1, 1999.

(51) Int. Cl. G02F 1/00

(52) U.S. Cl. 359/322; 359/321

(57) ABSTRACT

The achromatic variable view window or lens enables a user to change the views possible through a window from a given perspective point. One embodiment includes two variable electrooptically addressed materials, temperature regulating element, insulating layer, mounting structures, and operating software. The system relies on forming parallel and/or concentric circle arrays. Whereby the arrays are formulated such that varying the angle at which each of two materials transition between their respective ηₑ and ηₒ states produces a calculated and predictable deflection upon a poly chromatic incident ray while dispersion of the ray is reduced to a controllable tolerance. Objectives of this new art are to maximize refraction, control dispersion, and eliminate physical motion. It can operate as a variable angle achromatic prism when addressed in parallel arrays or a variable focal length achromatic lens when addressed in concentric circular arrays. Or it can operate as a multitude of both of these simultaneously. In another embodiment, photooptical addressing is used in place of electrooptic addressing. When user tracking and object tracking hardware feeds information to the operating software, the system can automatically adjust the variable view window (or lens) to keep an object in view and in focus for a user.

### CROSS-REFERENCE TO RELATED APPLICATIONS

This application is entitled to the benefit of patent application Ser. No. 09/358,175 filed Jul. 20, 1999, of patent application Ser. No. 60/149,059 filed Jun. 16, 1999, of patent application Ser. No. 60/149,059 filed Aug. 16, 1999, of patent application Ser. No. 60/162,988 filed Nov. 1, 1999, of patent application Ser. No. 09/469,407 filed Dec. 29, 1999, of patent application Ser. No. 09/500,493 filed Feb. 9, 2000, of patent application Ser. No. 09/575601 filed May 22, 2000, of patent application Ser. No. 09/596,744 filed Jun. 19, 2000, and of patent application Ser. No. 09/665,191 filed Sep. 18, 2000. This patent Application is a conversion of Provisional Patent Application Ser. No. 60/258,282 filed Dec. 26, 2000, and of Provisional Patent Application Ser. No. 60/259,363 filed Jan. 2, 2001.

### BACKGROUND

1. Field of Invention

This invention relates to windows that are mounted in a building or on a vehicle, specifically to improved design, structure and use of windows.

2. Description of Prior Art

Originally windows were created and manufactured to enable light to enter buildings and to enable those inside to see outside. For centuries the use and construction of windows changed little. Inventors experimented with incorporating different materials resulting in ornamental windows such as stained glass. By late in the twentieth century, advanced windows include many beneficial adaptations. Commonly, multiple panes are used to maximize energy efficiency often with vacuum or with injected gas between the panes. The widow panes incorporate many more substances added during various stages of production. These substances create various beneficial effects such as tinting and to manipulate selected band widths of electromagnetic energy in desirable ways. Most recently windows have incorporated means to adjust between clear and opaque states as desired. This adaptation effectively converges the historic window blind function into the window itself. Even with all the advances in window materials and manufacture, the main functions and generally passive role of windows have remained largely unchanged since their original conception and production many centuries ago and subsequent widespread use to this day.

The effect of variable refraction using liquid crystals was observed nearly a century ago. Subsequently, many well documented constructs have employed the variable refraction effect of electrooptic and photooptic prisms and lenses to achieve desirable objectives. Particularly computer monitors, photocopy machines, ray stabilizers, laser ray directing devices, and optical storage media have all widely used the variable refraction properties of liquid crystal prisms and lenses. Heretofore the concept, design and manufacture of electrooptic and photo optic prisms as functioning window panes incorporated into a building or vehicle has not existed. Converging window and liquid crystal prism technologies as herein described provides abundant and valuable benefits heretofore unrecognized and undressed in prior art.

### SUMMARY

The invention described herein incorporates the components of an optical system.

Said optical system in one embodiment consisting of a first material having variable refractive indices in series with a second material having variable refractive indices. Said refractive properties of said two materials having been matched such that the two materials operating in conjunction produce an achromatic refraction upon a beam of light incident thereon and passing through both materials in series. In the preferred embodiment, this series is utilized to form a window through which a user can view at alternate angles when operating as an achromatic prism. And through which a user can zoom in on objects when operating as an achromatic lens. Said series can operate in the prism mode and the lens mode simultaneously or alternately. Said series can operate in multiple prism and lens modes simultaneously or alternately. Additionally operating software is incorporated to manipulate the refractive properties of each of the two materials and to monitor the materials in series.

### OBJECTS AND ADVANTAGES

Accordingly, several objects and advantages of my invention are apparent. The invention increases the functions that a window performs in many circumstances. The invention also improves the aesthetic appeal provided by a window within a building.

Many people can not autonomously adjust their position to see the full pi steridian hemisphere possible on the outside of a window. By making the window itself adjustable as herein described, the user can select which portion of the external pi steridian hemisphere she wishes to view from nearly any single vantage point inside a structure. Moreover as provided herein, the view selected can again be altered whenever desired. Similarly, drivers of a vehicle are somewhat restricted regarding their physical mobility. Particularly, the prior art includes many examples intended to eliminate blind spots in a vehicle. The new art described herein enables a driver to manipulate the view provided by the window glass thereby eliminating blind spots without mirrors or reflecting prisms.

The value of each particular window (in a building, luxury cruise ship, or passenger aircraft for example) from an aesthetic standpoint is related to the beauty of the view it provides or illumination it affords. Heretofore, the view provided by a window in a building was limited to whatever view an architect had the foresight to plan into construction or was later altered externally. Some windows had excellent views and some windows had poor views. The view from any given vantage point within the building was virtually unalterable. As described herein, the present invention enables the view from a single vantage point through a single window to be infinitely altered in nearly a pi steradians hemisphere. Moreover different views can be selected nearly instantly and changed anytime desired. Thus a user can view a sunrise in the east and later a sunset in the west without ever altering their own perspective on the window. Also, a window high up a wall that historically only provided a view of the sky can be adjusted as described herein to provide views of the ground beneath it in any direction. All of these examples include greatly enhanced aesthetic appeal.

On board a luxury cruise ship or passenger aircraft, the invention described herein will enable passengers to manipulate windows to aesthetically improve the view they afford.

Similarly, the practicality of the view that a given window provides has heretofore been unalterable. The addition of mirrors to the external walls of a building or the sides of a vehicle have been used to enable the user to view different directions from a given vantage point. Alternately, cameras and monitors have been used to provide views. This invention uses variable refractive indices within the window to achieve alternate views. If the user wants to view the sidewalk or driveway outside of the building for example, she can adjust the window refraction instead of adjusting her vantage point or relying on other technology. If the driver of a vehicle wants to view the blind spot beside her vehicle, she can adjust the side window of her car to provide the view very comfortably through variable refraction within the window.

A user can also zoom in on objects using variable refraction within the window as described herein. This enables the user access to heretofore unprecedented, magnified views, achromatically. A driver, ship captain, or airline pilot using such technology can zoom in on objects without the need of binoculars or other hand held optics. This provides very significant advantages in an automobile, aircraft, ship, or in a building. Also provided herein are the means to by which the system can automatically adjust its focal length depending upon the eye position of its user and his physical distance for the object to be viewed.

Further objects and advantages will become apparent from a consideration of the drawings and ensuing description.

### DRAWING FIGS.

FIGS. 1 through 3 and FIG. 10 are prior art from Frey et al U.S. Pat. No. 4,066,334, 1978.

FIG. 4 is the present invention in a first state.

FIG. 5 shows an electrode in the positive 141 and an electrode in the negative 143.

FIG. 6 illustrates the next time sequence after FIG. 5.

FIG. 7 illustrates an array of similarly configured cells from FIG. 6.

FIG. 8 is a cross section illustrating the operation of the two liquid crystal materials together as a flat surface Fresnel lens.

FIG. 9 illustrates that several lens and prism zones can be present simultaneously on the same window.

FIG. 11 shows the present invention in a first state.

FIG. 12 is the same cell as FIG. 11 except now some of the transparent electrodes have been activated with electric charges.

FIG. 13 depicts that additional charges such as 57 and trimming charges such as 59 can be added to improve precision of the electric field in the system.

FIG. 14 represents the crystal alignment corresponding to the electric fields of FIG. 12.

FIG. 15 illustrates that the art of the present invention utilizes cells of FIG. 14 in series to reliably refract light while minimizing dispersion.

FIG. 16 is intended to illustrate that the cells are three dimensional.

FIG. 17 illustrates light passing through an array of the present invention in series.

FIG. 18 is a flowchart depicting electrooptic operation of a deflecting zone.

FIG. 19 is a flowchart depicting electrooptic operation of a magnifying zone.

FIG. 20 is an assembled electrooptic window deflecting a polychromatic ray achromatically.

FIG. 21a through FIG. 21g depict the succession of laser alignment steps taken to photooptically address a first photooptic material.

FIG. 22 illustrates an automatically adjusting magnification zone of a variable refractive achromatic window in operation.

FIG. 23 is a flowchart depicting photooptic operation of a deflecting zone.

FIG. 24 is a flowchart depicting photooptic operation of a magnification zone.

FIG. 25 includes three GUI windows included with the PreGradOpt operating software.

FIG. 26 includes three GUI windows included with the PreHalfGradOpt operating software.

FIG. 27 includes three GUI windows included with the Phoslo operating software.

### DESCRIPTION OF THE DRAWINGS and OPERATION

The following description of the invention and the related drawings portray a window such as would be mounted in the wall of a structure such as a building for an automobile in a series of preferred embodiments. It will be understood, however, that the concept of the invention may be employed in any substantially light-transmissive component, broadly described as a lens. The description of the invention relates to and is best understood with relation to the accompanying drawings, in which:

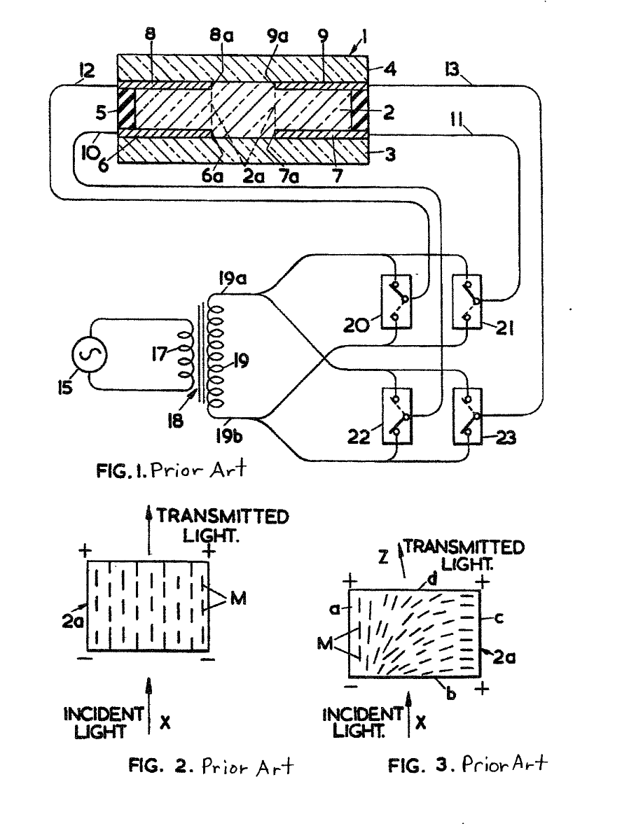

FIGS. 1 through 3 and FIG. 10 are prior art from Frey et al U.S. Pat. No. 4,066,334, 1978. FIG. 1 describes the construction of a liquid crystal well known to those in the art. Incorporated are electrical connections and transparent electrodes which enable electric fields to be variably produced within the liquid crystal cell. FIG. 2 shows the non-deflected light transmission through the cell when the liquid crystals are aligned I a first state. FIG. 3 shows the deflected light transmission through the cell when the liquid crystals are aligned in a second a second state such that a gradient is formed when crystals are aligned with an electric field.

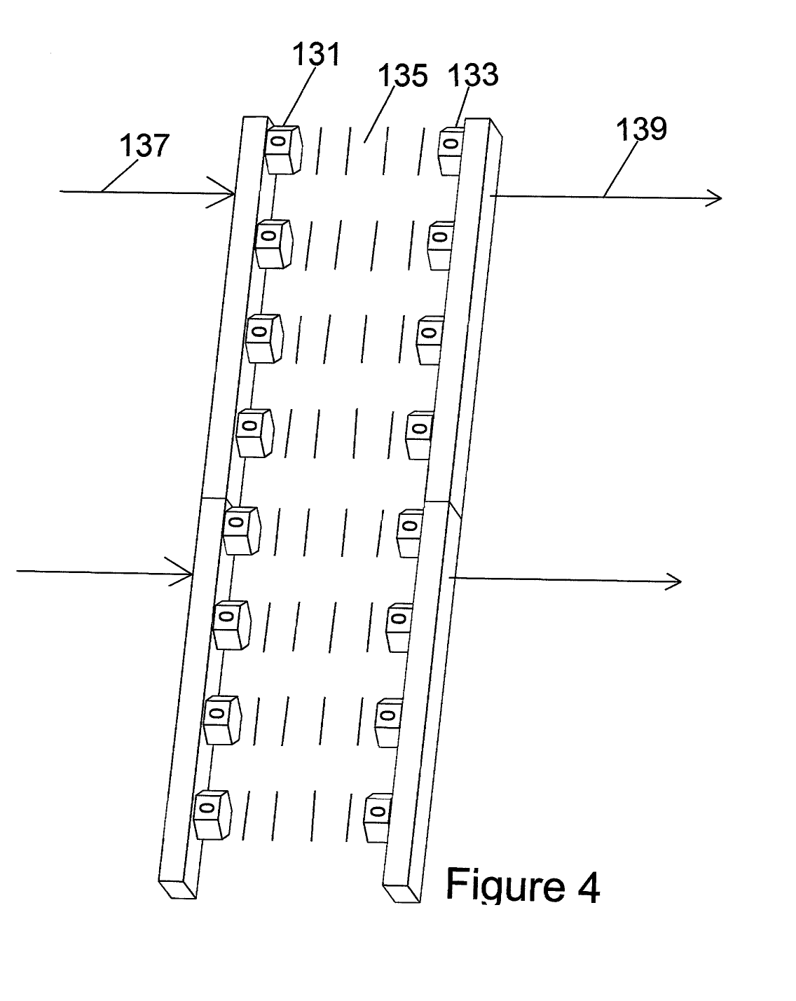

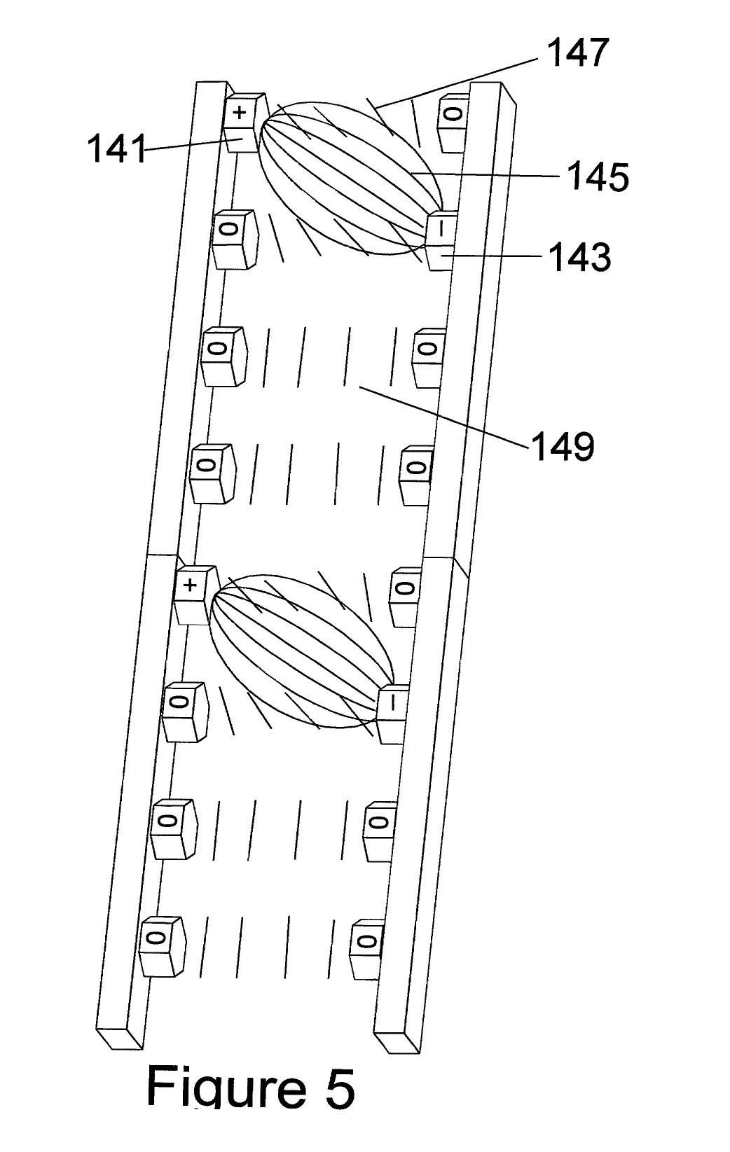

A first embodiment (FIGS. 4 through 8) uses techniques similar to those of the FIG. 1 through 3 (Frey) prior art. They differ from Frey in that they are cells in array and they differ from all prior art in that they use liquid crystals in series to achromatically deflect light and they are computer operated to achieve this end.

FIG. 4 is the present invention in a first state. It can be either the ηₒ or the ηₑ state. Incident light 137 exits the system at 139 the same angle at which it was incident. 131 is one of an array of transparent electrodes currently at zero charge. 135 is a first liquid crystal. 133 is a second electrode at zero charge. The second liquid crystal array is not shown but is similarly constructed. This construct is similar to the prior art of FIG. 2 except that the present art comprises many electro-optic cells in array.

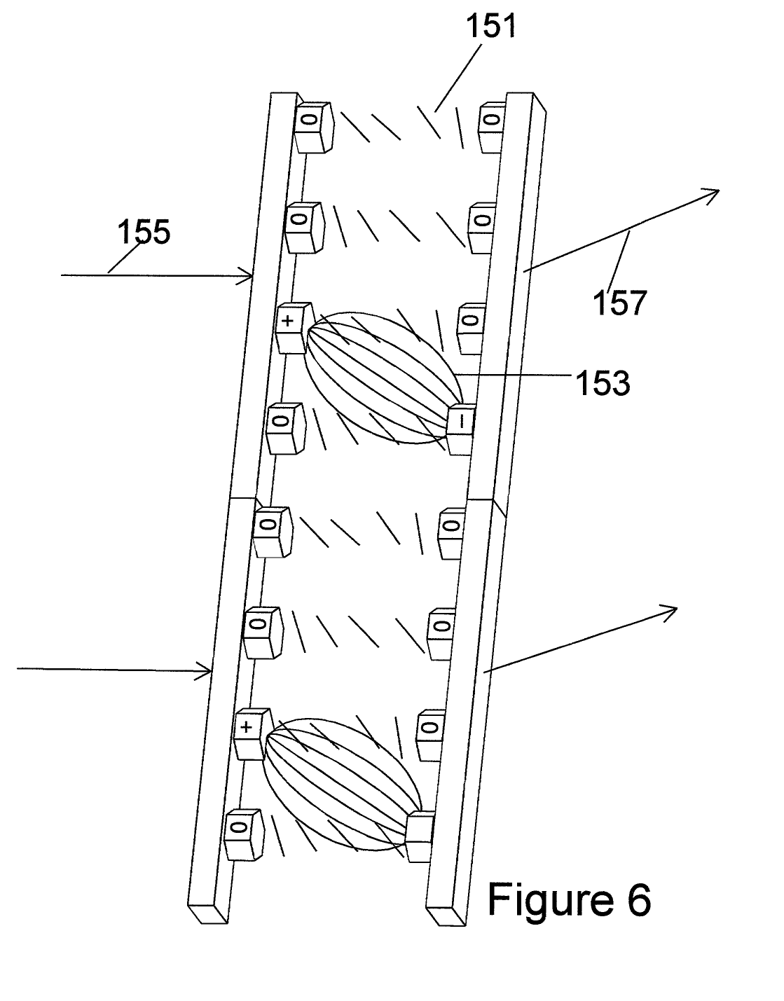

FIG. 5 shows the construct of FIG. 4 with some electric fields. Some electrodes are positive such as a positive electrode 141 and other electrodes are negative such as negative electrode 143. A gradient prism is thereby created. Alternate sections of the liquid crystal array are likewise charged while adjoining sections are not so charged (such as an adjoining section 149). This is to minimize crosstalk current between adjoining sections. The second liquid crystal material is not shown but is similarly constructed and operated.

FIG. 6 illustrates the cell of FIG. 5 in the next time sequence. The prism created in FIG. 5 is still present as area 151. The adjoining area is now also realigned into a gradient index prism by electric field 153. At this time all of the liquid crystals have been realigned either by the currently charged electrodes or by the previously charged electrodes. The other liquid crystal material in series is not shown but is similarly operated in sequential cycles with alternate sections alternating between the “on” and “off” states such that the gradient prism is uniformly maintained.

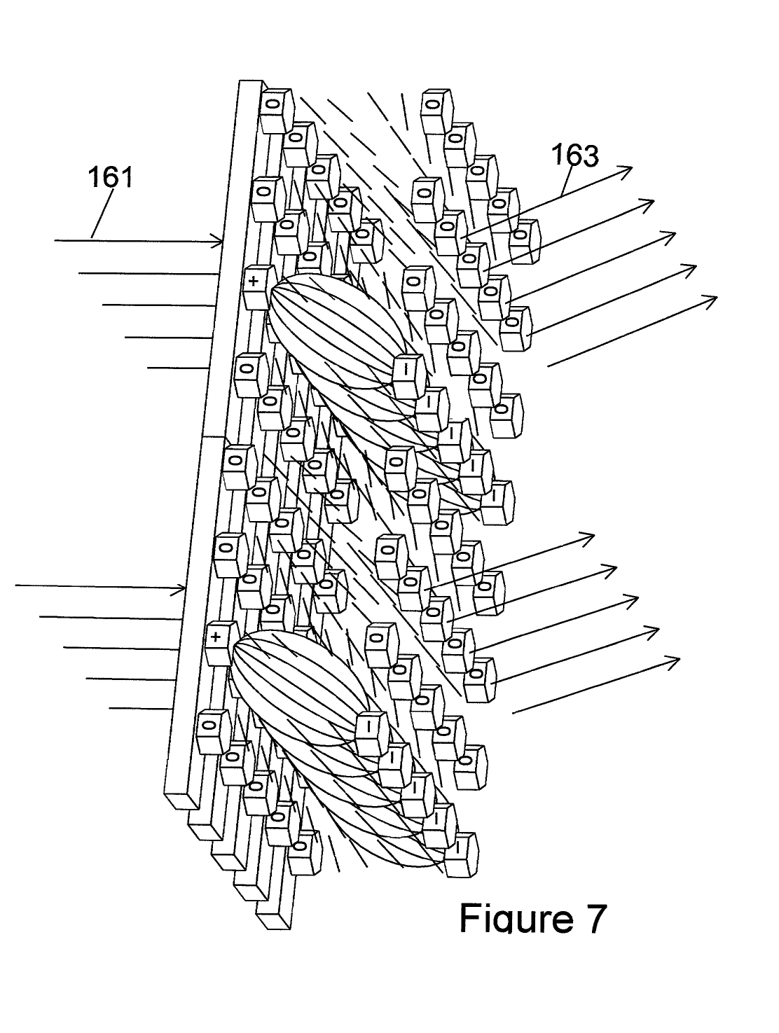

FIG. 7 illustrates an array of similarly configured cells from FIG. 6. Entering light 161 exits at a refracted angle 163. The second liquid crystal material is similarly operated, though not shown.

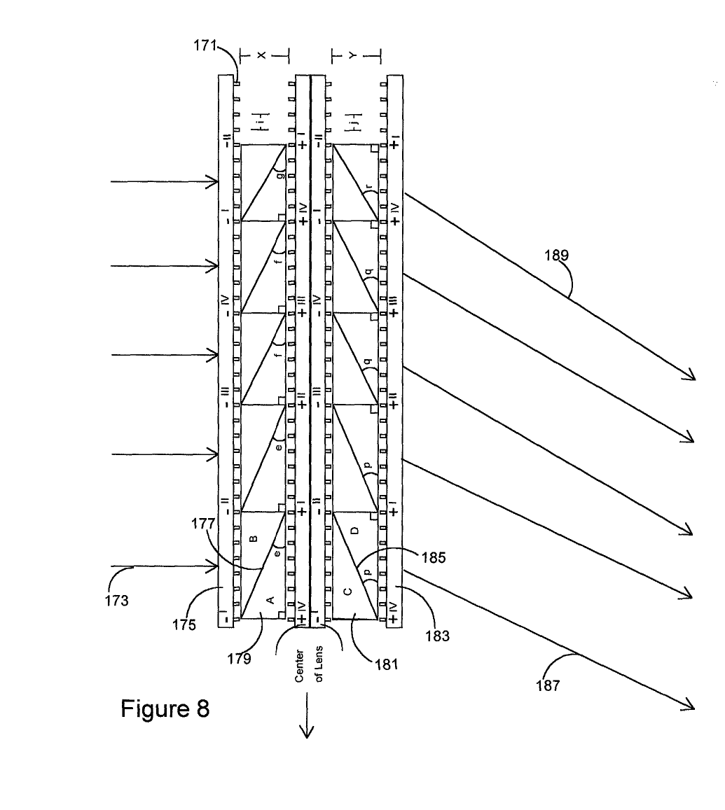

FIG. 8 Illustrates the operation of the two liquid crystal materials together as a flat surface Fresnel lens. 171 is a transparent electrode, (one of many). A polychromatic light beam enters 173. It passes through the first transparent substrate. The first liquid crystal is transitioning between the ηₑ State B and the ηₒ state A at the offset angle “e”. 177 is a line depicting this angle. The second liquid crystal is transitioning from its ηₑ state C and its ηₒ state D at a second offset “p”. 185 is a line depicting this angle. The light then passes out of the second substrate. The exiting inner light 187 is refracted with minimized dispersion (achromatic). Note that the refraction angle of inner light 187 is different than that of outer light 189. This is because the gradient angle at which the materials transition between their ηₑ and ηₒ states purposefully varies. To form a lens with consistent focal length, the gradient is varied in concentric circles around a lens axis (not shown but located at the center of lens). The arrow points to the “center of lens”.

The gradient of the first electro-optic material is coordinated with that of the second electro-optic material using the PreGradOpT software herein which operates the first embodiment.

TABLE I lists the PreGradOpT mathematical logic in C++ that is used to calculate trajectories of two frequencies of light through the two electro-optic materials. Each of said electro-optic materials forming a gradient index prism operating between its respective ηₑ and ηₒ states at respective angles that can be varied. Thereby producing variable net achromatic refraction. The below logic does not consider whether the polar axis differs from the pair of optical axis in which case an additional variable is required to calculate offset angles required to compensate for the differences in axis.

Ref1 = asin (sin (Inc1) /Mat2L) ;
AvgMat = (fabs (Off2) / (0.5*PI) ) *Mat2LS2+ (1-

(fabs (Off2) / (0.5*PI) ) ) *Mat2L;

GradOff = Off2/2;
x = Mat2L*sin (Ref1+GradOff) /AvgMat;
if (fabs (x) <=1)

Ref2 = asin (x) ;

else

Nan = true;

x = sin (Inc1) /Mat2L;
if (fabs (x) <=1)

Ref1a = asin (x) ;

else

Nan = true;

MatGrad = (AvgMat-Mat2L) /3;
x = Mat2L*sin (Ref1a+GradOff/2) / (Mat2L+MatGrad) ;
if (fabs (x) <=1)

Ref2a = asin (x) ;

else

Nan = true;

x =

(Mat2L+MatGrad) *sin (Ref2a+GradOff/2) / (Mat2L+2*MatGrad) ;

if (fabs (x) <=1)

Ref3a = asin (x) ;

else

Nan = true;

x =

(Mat2L+2*MatGrad) *sin (Ref3ax+GradOff/2) /AvgMat;

if (fabs (x) <=1)

Ref3a = asin (x) ;

else

Nan = true;

DRef = (Ref3a-Ref2) *GradMult+Ref3a;
x = AvgMat*sin (DRef) /Mat2LS2;
if (fabs (x) <=1)

Ref3 = asin (x) ;

else

Nan = true;

x = Mat2LS2*sin (Ref3-GradOff) /Mat3L;
if (fabs (x) <=1)

Ref4 = asin (x) ;

else

Nan = true;

x = AvgMat*sin (DRef) / (AvgMat+MatGrad) ;
if (fabs (x) <=1)

Ref4a = asin (x) ;

else

Nan = true;

x = (AvgMat+MatGrad) *sin (Ref4a-

GradOff/2) / (AvgMat+MatGrad*2) ;

if (fabs (x) <1)

Ref5ax = asin (x) ;

else

Nan = true;

x = (AvgMat+MatGrad*2) *sin (Ref5ax-

GradOff/2) /Mat2LS2;

if (fabs (x) <=1)

Ref5a = asin (x) ;

else

Nan = true;

x = Mat2LS2*sin (Ref5a-GradOff/2) /Mat3L;
if (fabs (x) <=1)

Ref6a = asin (x);

else

Nan = true;

double FRefL = (Ref6a-Ref4) *GradMult+Ref6a;

////////////////////////////////////////////////////////////

Ref1 = asin (sin (Inc1) /Mat2H) ;
AvgMat = (fabs (Off2) / (0.5*PI) ) *Mat2HS2+ (1-

(fabs (Off2) / (0.5*PI) ) ) *Mat2H;

GradOff = Off2/2;
x = Mat2H*sin (Ref1+GradOff) /AvgMat;
if (fabs (x) <=1)

Ref2 = asin (x) ;

else

Nan = true;

x = sin (Inc1) /Mat2H;
if (fabs (x) <=1)

Ref1a = asin (x) ;

else

Nan = true;

MatGrad = (AvgMat-Mat2H) /3;
x = Mat2H*sin (Ref1a+GradOff/2) / (Mat2H+MatGrad) ;
if (fabs (x) <=1)

Ref2a = asin (x) ;

else

Nan = true;

x =

(Mat2H+MatGrad) *sin (Ref2a+GradOff/2) / (Mat2H+2*MatGrad) ;

if (fabs (x) <=1)

Ref3ax = asin (x) ;

else

Nan = true;

x =

(Mat2H+2*MatGrad) *sin (Ref3ax+GradOff/2) /AvgMat;

if (fabs (x) <=1)

Ref3a = asin (x) ;

else

Nan = true;

DRef = (Ref3a-Ref2) *GradMult+Ref3a;
x = AvgMat*sin (DRef) /Mat2HS2;
if (fabs (x) <=1)

Ref3 = asin (x) ;

else

Nan = true;

x = Mat2HS2*sin (Ref3-GradOfff) /Mat3H;
if (fabs (x) <=1)

Ref4 = asin (x) ;

else

Nan = true;

x = AvgMat*sin (DRef) / (AvgMat+MatGrad) ;
if (fabs (x) <=1)

Ref4a = asin (x) ;

else

Nan = true;

x = (AvgMat+MatGrad) *sin (Ref4a-

GradOff/2) / (AvgMat+MatGrad*2) ;

if (fabs (x) <=1)

Ref5ax = asin (x) ;

else

Nan = true;

x = (AvgMat+MatGrad*2) *sin (Ref5ax-

GradOff/2) /Mat2HS2;

if (fabs (x) <=1)

Ref5a = asin (x) ;

else

Nan = true;

x = Mat2HS2*sin (Ref5a-GradOff/2) /Mat3H;
if(fabs (x) <=1)

Ref6a = asin (x) ;

else

Nan = true;

double FRefH = (Ref6a-Ref4) *GradMult+Ref6a;

////////////////////////////////////////////////////////////
/

AvgMat = (fabs (Off3) / (0.5*PI) ) *Mat3LS2+(1-

(fabs (Off3) / (0.5*PI) ) ) *Mat3L;

GradOff = Off3/2;
x = Mat3L*sin (FRefL+GradOff) /AvgMat;
if (fabs (x) <=1)

Ref2 = asin (x) ;

else

Nan = true;

x = sin (Inc1) /Mat3L;
if (fabs (x) <=1)

Ref1a = asin (x) ;

else

Nan = true;

MatGrad = (AvgMat-Mat3L) /3;
x = Mat3L*sin(FRefL+GradOff/2) / (Mat3L+MatGrad) ;
if (fabs (x) <=1)

Ref2a = asin (x) ;

else

Nan = true;

x =

(Mat3L+MatGrad) *sin(Ref2a+GradOff/2) / (Mat3L+2*MatGrad) ;

if (fabs (x) <=1)

Ref3ax = asin (x) ;

else

Nan = true;

x =

(Mat3L+2*MatGrad) *sin (Ref3ax+GradOff/2) /AvgMat;

if (fabs (x) <=1)

Ref3a = asin (x) ;

else

Nan = true;

DRef = (Ref3a-Ref2) *GradMult+Ref3a;
x = AvgMat*sin (DRef) /Mat3LS2;
if (fabs (x) <=1)

Ref3 = asin (x) ;

else

Nan = true;

x = Mat3LS2*sin (Ref3-GradOff) ;
if (fabs (x) <=1)

Ref4 = asin (x) ;

else

Nan = true;

x = AvgMat*sin (DRef) / (AvgMat+MatGrad) ;
if (fabs (x) <=1)

Ref4a = asin (x) ;

else

Nan = true;

x = (AvgMat+MatGrad)*sin (Ref4a-

GradOff/2) / (AvgMat+MatGrad*2) ;

if (fabs (x) <=1)

Ref5ax = asin (x) ;

else

Nan = true;

x = (AvgMat+MatGrad*2) *sin (Ref5ax-

GradOff/2) /Mat3LS2;

if (fabs (x) <=1)

Ref5a = asin (x) ;

else

Nan = true;

x = Mat3LS2*sin (Ref5a-GradOff/2) ;
if (fabs (x) <=1)

Ref6a = asin (x) ;

else

Nan = true;

FRefL = (Ref6a-Ref4) *GradMult+Ref6a;

////////////////////////////////////////////////////////////
////

AvgMat = (fabs (Off3) / (0.5*PI) ) *Mat3HS2+ (1-

(fabs (Off3) / (0.5*PI) ) ) *Mat3H;

GradOff = Off3/2;
x = Mat3H*sin (FRefH+GradOff) /AvgMat;
if (fabs (x) <=1)

Ref2 = asin (x) ;

else

Nan = true;

x = sin (Inc1) /Mat3H;
if (fabs (x) <=1)

Ref1a = asin (x) ;

else

Nan = true;

MatGrad = (AvgMat-Mat3H) /3;
x = Mat3H*sin (FRefH+GradOff/2) / (Mat3H+MatGrad) ;
if (fabs (x) <=1)

Ref2a = asin (x) ;

else

Nan = true;

x =

(Mat3H+MatGrad) *sin (Ref2a+GradOff/2) / (Mat3H+2*MatGrad) ;

if (fabs (x) <=1)

Ref3ax = asin (x) ;

else

Nan = true;

x =

(Mat3H+2*MatGrad) *sin (Ref3ax+GradOff/2) /AvgMat;

if (fabs (x) <=1)

Ref3a = asin (x) ;

else

Nan = true;

DRef = (Ref3a-Ref2) *GradMult+Ref3a;
x = AvgMat*sin (DRef) /Mat3HS2;
if (fabs (x) <=1)

Ref3 = asin (x) ;

else

Nan = true;

x = Mat3HS2*sin (Ref3-GradOff) ;
if (fabs (x) <=1)

Ref4 = asin (x) ;

else

Nan = true;

x = AvgMat*sin (DRef) / (AvgMat+MatGrad) ;
if (fabs (x) <=1)

Ref4a = asin (x) ;

else

Nan = true;

x = (AvgMat+MatGrad)*sin (Ref4a-

GradOff/2) / (AvgMat+MatGrad*2) ;

if(fabs (x) <=1)

Ref5ax = asin (x) ;

else

Nan = true;
x = (AvgMat+MatGrad*2) *sin (Ref5ax-

GradOff/2) /Mat3HS2;

if (fabs (x) <=1)

Ref5a = asin (x) ;

else

Nan = true;

x = Mat3HS2*sin (Ref5a-GradOff/2) ;
if (fabs (x) <=1)

Ref6a = asin (x) ;

else

Nan = true;

FRefH = (Ref6a-Ref4) *GradMult+Ref6a;

////////////////////////////////////////////////////////////
///////

double Rell;
if (FRefH<0&&FRefL>0 || FRefH>0&&FRefL<0)

Rell = fabs (FRefH) + fabs (FRefL) ;

else

Rell = fabs (FRefH - FRefL) ;

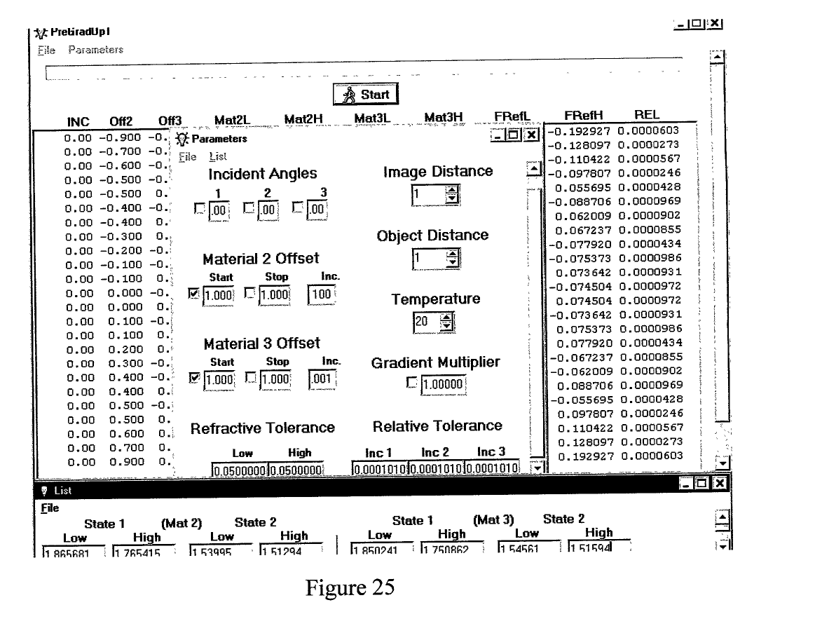

TABLE II illustrates some of the range of achromatic deflection angles that are achievable for a combination of two materials operating in a gradient between their [symbol] e and [symbol] o states at variable transition angles between these states. The software of Table I and the GUI of FIG. 25 are used to produce the desired refractive states. Mat2 has been described by Schirmer and is listed in table III as “21 nPZPOm”. Mat3 has also been described by Schirmer and is listed in Table III as “25 nOPP”. The resultants describe the deflection angle, through only negative deflections are shown here, positive deflections of equal magnitude will be produced by using Offsets of opposite signs. Also deflections of magnitudes smaller than I.1I have been omitted from the table but the range does go to zero. The Mat2 Offset describes the angle at which Mat2 transitions from refractive index State I to refractive index State II to form a gradient prism. The Mat3 Offset describes the angle at which Mat3 transitions from State I to State II to form a gradient prism. The operating temperature herein is 20 degrees Celsius but the software can use liquid crystal temperature as input to modify offset angles. (The refractive indices at only one frequency are described in this table while the computer software considers a miinimum of 2 frequencies to minimize dispersion).

| Incident | Offset | Offset | State I | State II | State I | State II | Resultant of | Resultant of | Relative |
|---|---|---|---|---|---|---|---|---|---|
| Angle | Mat2 | Mat3 | Mat2 | Mat2 | Mat3 | Mat3 | Frequency 1 | Frequency 2 | Dispersion |
| 0 | −0.98 | −0.63 | 1.865681 | 1.765415 | 1.850241 | 1.750862 | −0.243297 | −0.243382 | 8.49E−05 |
| 0 | −0.97 | −0.64 | 1.865681 | 1.765415 | 1.850241 | 1.750862 | −0.235515 | −0.235611 | 9.58E−05 |
| 0 | −0.92 | −0.682 | 1.865681 | 1.765415 | 1.850241 | 1.750862 | −0.203353 | −0.203408 | 5.53E−05 |
| 0 | −0.91 | −0.689 | 1.865681 | 1.765415 | 1.850241 | 1.750862 | −0.198131 | −0.19804 | 9.03E−05 |
| 0 | −0.9 | −0.696 | 1.865681 | 1.765415 | 1.850241 | 1.750862 | −0.192866 | −0.192928 | 6.21E−05 |
| 0 | −0.85 | −0.726 | 1.865681 | 1.765415 | 1.850241 | 1.750862 | −0.17095 | −0.171008 | 5.82E−05 |
| 0 | −0.81 | −0.746 | 1.865681 | 1.765415 | 1.850241 | 1.750862 | −0.156832 | −0.156841 | 0.000009 |
| 0 | −0.79 | −0.755 | 1.865681 | 1.765415 | 1.850241 | 1.750862 | −0.150625 | −0.15063 | 4.9E−06 |
| 0 | −0.74 | −0.775 | 1.865681 | 1.765415 | 1.850241 | 1.750862 | −0.137192 | −0.137153 | 3.83E−05 |
| 0 | −0.7 | −0.789 | 1.865681 | 1.765415 | 1.850241 | 1.750862 | −0.128125 | −0.128098 | 2.65E−05 |
| 0 | −0.63 | −0.81 | 1.865681 | 1.765415 | 1.850241 | 1.750862 | −0.1151 | −0.115094 | 0.000006 |
| 0 | −0.6 | −0.818 | 1.865681 | 1.765415 | 1.850241 | 1.750862 | −0.110366 | −0.110423 | 5.74E−05 |
| 0 | −0.58 | −0.823 | 1.865681 | 1.765415 | 1.850241 | 1.750862 | −0.107468 | −0.107563 | 9.46E−05 |
| 0 | −0.57 | −0.825 | 1.865681 | 1.765415 | 1.850241 | 1.750862 | −0.106234 | −0.106186 | 4.77E−05 |
| 0 | −0.54 | −0.832 | 1.865681 | 1.765415 | 1.850241 | 1.750862 | −0.102315 | −0.102371 | 5.64E−05 |
| 0 | −0.53 | −0.834 | 1.865681 | 1.765415 | 1.850241 | 1.750862 | −0.101164 | −0.10117 | 6.5E−06 |
| 0 | −0.52 | −0.836 | 1.865681 | 1.765415 | 1.850241 | 1.750862 | −0.100033 | −0.10001 | 2.27E−05 |

TABLE III lists some materials that may be further investigated as Mat2 and Mat3 materials (in any of the embodiments described herein) due to their ability to operate between known [symbol] o and [symbol] e states. The following were used as references in confirming these properties. EM Industries, Hawthorne, N.Y., product literature with Cauchy Constants. Schirmer,Jorg, et al, “Birefringence and Refractive Indices Dispersion of Different Liquid Crystalline Structures”, Molecular Crystals, Liquid Crystals, 1997, Vol. 307, pp. 17-41, Amsterdam, B.V., Gordon and Breach. Weber,Marvin, CRC Handbook of Laser Science and Technology, Supplement 2: Optical Materials, 1995 CRC Press, Boca Raton, Fla.

| | | | Low | High | Index of | Index of | Index of | Index of |
|---|---|---|---|---|---|---|---|---|
| | | Temp | Wave- | Wave- | Refraction | Refraction | Refraction | Refraction |
| Source | Material | C. | length | length | MATL Ne | MATH Ne | MATL No | MATH No |
| Schirmer | 10 nPACOm | 20 | 435.8 | 643.8 | 1.58704 | 1.56569 | 1.49733 | 1.48276 |
| Schirmer | 10 nPACOm | 40 | 435.8 | 643.8 | 1.57062 | 1.55119 | 1.49346 | 1.47921 |
| | 11 | | | | | | | |
| | nPACOm + nOP | | | | | | | |
| Schirmer | EPOm | 20 | 435.8 | 643.8 | 1.67386 | 1.63431 | 1.51661 | 1.49709 |
| | 11 | | | | | | | |
| | nPACOm + nOP | | | | | | | |
| Schirmer | EPOm | 50 | 435.8 | 643.8 | 1.64768 | 1.61141 | 1.51489 | 1.49504 |
| Schirmer | 12 nBEPF | 20 | 435.8 | 643.8 | 1.55902 | 1.54149 | 1.49917 | 1.48514 |
| Schirmer | 12 nBEPF | 30 | 435.8 | 643.8 | 1.55081 | 1.53424 | 1.49748 | 1.48356 |
| | 13 | | | | | | | |
| | nCAPF + nBAP | | | | | | | |
| Schirmer | PF | 20 | 435.8 | 643.8 | 1.59910 | 1.57272 | 1.50631 | 1.48963 |
| | 13 | | | | | | | |
| | nCAPF + nBAP | | | | | | | |
| Schirmer | PF | 30 | 435.8 | 643.8 | 1.59014 | 1.56489 | 1.50409 | 1.48767 |
| | 15 | | | | | | | |
| Schirmer | nPEP + nCPEP | 20 | 435.8 | 643.8 | 1.72813 | 1.67885 | 1.52473 | 1.50305 |
| | 15 | | | | | | | |
| Schirmer | nPEP + nCPEP | 70 | 435.8 | 643.8 | 1.67186 | 1.62879 | 1.52201 | 1.49823 |
| Schirmer | 16 nCPEPm | 20 | 435.8 | 643.8 | 1.67292 | 1.63248 | 1.52788 | 1.50614 |
| Schirmer | 16 nCPEPm | 30 | 435.8 | 643.8 | 1.66723 | 1.62760 | 1.52457 | 1.50308 |
| Schirmer | 17 nGCPEm | 15 | 435.8 | 643.8 | 1.56712 | 1.54202 | 1.52673 | 1.50564 |
| | 18 | | | | | | | |
| | nCPm + PCN + n | | | | | | | |
| | PCNm + nOPAN | | | | | | | |
| Schirmer | m + nCANCPm | 20 | 435.8 | 643.8 | 1.58818 | 1.56797 | 1.50865 | 1.49417 |
| | 18 | | | | | | | |
| | nCPm + PCN+ n | | | | | | | |
| | PCNm + nOPAN | | | | | | | |
| Schirmer | m + nCANCPm | 50 | 435.8 | 643.8 | 1.56179 | 1.54252 | 1.50318 | 1.48819 |
| | 19 | | | | | | | |
| Schirmer | nGCP + nCEP | 20 | 435.8 | 643.8 | 1.61751 | 1.58957 | 1.50954 | 1.49223 |
| | 19 | | | | | | | |
| Schirmer | nGCP + nCEP | 30 | 435.8 | 643.8 | 1.60623 | 1.57922 | 1.50923 | 1.49229 |
| Schirmer | 1nCP | 20 | 435.8 | 643.8 | 1.63579 | 1.60716 | 1.50361 | 1.48788 |
| Schirmer | 1nCP | 50 | 435.8 | 643.8 | 1.58993 | 1.56517 | 1.50412 | 1.48790 |
| Schirmer | 20 nCEP | 20 | 435.8 | 643.8 | 1.62515 | 1.59634 | 1.49590 | 1.47947 |
| Schirmer | 20 nCEP | 60 | 435.8 | 643.8 | 1.58989 | 1.56470 | 1.48739 | 1.47192 |
| Schirmer | 21 nPZPOm | 20 | 435.8 | 643.8 | 1.86568 | 1.76542 | 1.53995 | 1.51294 |
| Schirmer | 21 nPZPOm | 40 | 435.8 | 643.8 | 1.83153 | 1.73923 | 1.54288 | 1.51313 |
| Schirmer | 22 nOPP(1)m | 40 | 435.8 | 643.8 | 1.66736 | 1.62078 | 1.49517 | 1.48186 |
| Schirmer | 22 nOPP(1)m | 70 | 435.8 | 643.8 | 1.62267 | 1.58396 | 1.50312 | 1.48702 |
| Schirmer | 23 nCE | 20 | 435.8 | 643.8 | 1.51809 | 1.50725 | 1.46327 | 1.45459 |
| Schirmer | 23 nCE | 70 | 435.8 | 643.8 | 1.47744 | 1.46856 | 1.44680 | 1.43868 |
| Schirmer | 24 nPZZPOm | 30 | 435.8 | 643.8 | 2.00811 | 1.86191 | 1.55049 | 1.51555 |
| Schirmer | 24 nPZZPOm | 40 | 435.8 | 643.8 | 1.99480 | 1.85265 | 1.55099 | 1.51582 |
| Schirmer | 25 nOPP | 20 | 435.8 | 643.8 | 1.85024 | 1.75086 | 1.54561 | 1.51594 |
| Schirmer | 25 nOPP | 50 | 435.8 | 643.8 | 1.79958 | 1.71052 | 1.54837 | 1.51580 |
| Schirmer | 26 nOPOm | 20 | 435.8 | 643.8 | 1.58766 | 1.56451 | 1.50719 | 1.49077 |
| Schirmer | 26 nCPOm | 30 | 435.8 | 643.8 | 1.56732 | 1.54553 | 1.50948 | 1.49224 |
| Schirmer | 27 nDP | 20 | 435.8 | 643.8 | 1.61507 | 1.58789 | 1.49911 | 1.48267 |
| Schirmer | 27 nDP | 40 | 435.8 | 643.8 | 1.58300 | 1.55827 | 1.50179 | 1.48419 |
| Schirmer | 28nCECm | 20 | 435.8 | 643.8 | 1.51156 | 1.50004 | 1.46919 | 1.45870 |
| Schirmer | 28nCECm | 30 | 435.8 | 643.8 | 1.50403 | 1.49302 | 1.46613 | 1.45619 |
| Schirmer | 2nCP | 20 | 435.8 | 643.8 | 1.62225 | 1.59309 | 1.51216 | 1.49459 |
| Schirmer | 2nCP | 30 | 435.8 | 643.8 | 1.59988 | 1.57187 | 1.51586 | 1.49734 |
| Schirmer | 3nCEPOm | 20 | 435.8 | 643.8 | 1.58043 | 1.55874 | 1.49284 | 1.47849 |
| Schirmer | 3nCEPOm | 50 | 435.8 | 643.8 | 1.55632 | 1.53701 | 1.48554 | 1.47167 |
| Schirmer | 4nCEPOm | 20 | 435.8 | 643.8 | 1.58615 | 1.56432 | 1.49123 | 1.47796 |
| Schirmer | 4nCEPOm | 50 | 435.8 | 643.8 | 1.56410 | 1.54351 | 1.48378 | 1.47010 |
| Schirmer | 5nCPS | 20 | 435.8 | 643.8 | 1.76642 | 1.70637 | 1.54221 | 1.51784 |
| Schirmer | 5nCPS | 30 | 435.8 | 643.8 | 1.74943 | 1.69195 | 1.54359 | 1.51853 |
| Schirmer | 6nCPS | 20 | 435.8 | 643.8 | 1.72484 | 1.67087 | 1.54295 | 1.51747 |
| Schirmer | 6nCPS | 30 | 435.8 | 643.8 | 1.70630 | 1.65520 | 1.54458 | 1.51859 |
| Schirmer | 7nPP | 20 | 435.8 | 643.8 | 1.79308 | 1.71490 | 1.55544 | 1.52467 |
| Schirmer | 7nPP | 30 | 435.8 | 643.8 | 1.76649 | 1.69356 | 1.56179 | 1.52872 |
| Schirmer | 8nPEP | 20 | 435.8 | 643.8 | 1.71965 | 1.66836 | 1.53122 | 1.50649 |
| Schirmer | 8nPEP | 40 | 435.8 | 643.8 | 1.68317 | 1.63622 | 1.53561 | 1.50912 |
| | 9nCAPF + nCPA | | | | | | | |
| Schirmer | Pm | 20 | 435.8 | 643.8 | 1.56916 | 1.55253 | 1.49619 | 1.48428 |
| | 9nCAPF + nCPA | | | | | | | |
| Schirmer | Pm | 40 | 435.8 | 643.8 | 1.55512 | 1.53889 | 1.49213 | 1.48005 |
| EM | | | | | | | | |
| Industries | BL009 | 20 | 435.8 | 643.8 | 1.58026 | 1.55937 | 1.49297 | 1.47879 |
| Weber | E1 BDHLtd | 17 | 436 | 644 | 1.79600 | 1.71800 | 1.54750 | 1.52030 |
| Weber | E1 BDHLtd | 36 | 436 | 644 | 1.73500 | 1.66810 | 1.56050 | 1.52930 |
| Weber | E2 BDHLtd | 0 | 436 | 644 | 1.83270 | 1.74660 | 1.54760 | 1.52060 |
| Weber | E2 BDHLtd | 25 | 436 | 644 | 1.79130 | 1.71240 | 1.54920 | 1.52000 |
| Weber | E3 BDHLtd | 0 | 436 | 644 | 1.84580 | 1.75370 | 1.54660 | 1.51870 |
| Weber | E3 BDHLtd | 20 | 436 | 644 | 1.81570 | 1.73080 | 1.54610 | 1.51750 |
| Weber | E3 BDHLtd | 49 | 436 | 644 | 1.74590 | 1.67340 | 1.55750 | 1.52360 |
| Weber | E4 BDHLtd | 0 | 436 | 644 | 1.83030 | 1.74270 | 1.53950 | 1.51410 |
| Weber | E4 BDHLtd | 20 | 436 | 644 | 1.80590 | 1.72170 | 1.54020 | 1.51220 |
| Weber | E4 BDHLtd | 56 | 436 | 644 | 1.72590 | 1.65680 | 1.54880 | 1.51800 |
| EM | | | | | | | | |
| Industries | E49 | 20 | 435.8 | 643.8 | 1.87520 | 1.77497 | 1.55631 | 1.52456 |
| Weber | E5 BDHLtd | 0 | 436 | 644 | 1.83320 | 1.74650 | 1.54510 | 1.51850 |
| Weber | E5 BDHLtd | 20 | 436 | 644 | 1.80380 | 1.72220 | 1.54470 | 1.51690 |
| Weber | E5 BDHLtd | 49 | 436 | 644 | 1.71830 | 1.65280 | 1.56420 | 1.53000 |
| Weber | E7 BDHLtd | 0 | 436 | 644 | 1.84810 | 1.75890 | 1.54620 | 1.51960 |
| Weber | E7 BDHLtd | 20 | 436 | 644 | 1.82080 | 1.73540 | 1.54400 | 1.51750 |
| Weber | E7 BDHLtd | 57 | 436 | 644 | 1.71740 | 1.65210 | 1.56360 | 1.53070 |
| | K15 | | | | | | | |
| | (5CB)(BDH,Ltd) | | | | | | | |
| Weber | | 20 | 436 | 644 | 1.79470 | 1.71650 | 1.55600 | 1.52750 |
| | K15 | | | | | | | |
| | (5CB)(BDH,Ltd) | | | | | | | |
| Weber | | 35 | 436 | 644 | 1.71300 | 1.66030 | 1.58000 | 1.54500 |
| | K21 | | | | | | | |
| | (7CB)(BDH,Ltd) | | | | | | | |
| Weber | ) | 22 | 436 | 644 | 1.76900 | 1.70010 | 1.54150 | 1.51480 |
| | K21 | | | | | | | |
| | (706)(BDH,Ltd) | | | | | | | |
| Weber | | 41 | 436 | 644 | 1.71400 | 1.65260 | 1.55170 | 1.52360 |
| EM | MCL-10100- | | | | | | | |
| Industries | 000 | 20 | 435.8 | 643.8 | 1.62335 | 1.59385 | 1.50185 | 1.48530 |
| EM | MCL-10100- | | | | | | | |
| Industries | 100 | 20 | 435.8 | 643.8 | 1.69105 | 1.64768 | 1.51604 | 1.49635 |
| EM | MCL-12000- | | | | | | | |
| Industries | 000 | 20 | 435.8 | 643.8 | 1.58246 | 1.55777 | 1.48922 | 1.47079 |
| EM | | | | | | | | |
| Industries | MLC-6043-000 | 20 | 435.8 | 643.8 | 1.58153 | 1.55827 | 1.48463 | 1.46939 |
| EM | | | | | | | | |
| Industries | MLC-6043-100 | 20 | 435.8 | 643.8 | 1.60081 | 1.57529 | 1.49178 | 1.47733 |
| EM | | | | | | | | |
| Industries | MLC-6225-000 | 20 | 435.8 | 643.8 | 1.60298 | 1.57731 | 1.49815 | 1.48236 |
| EM | MLC-6225-100 | 20 | 435.8 | 643.8 | 1.62162 | 1.59040 | 1.50478 | 1.48669 |
| Industries | | | | | | | | |
| EM | | | | | | | | |
| Industries | MLC-6256 | 20 | 435.8 | 643.8 | 1.60141 | 1.57356 | 1.50992 | 1.49593 |
| EM | | | | | | | | |
| Industries | MLC-6293 | 20 | 435.8 | 643.8 | 1.64969 | 1.61350 | 1.50605 | 1.48782 |
| EM | | | | | | | | |
| Industries | MLC-6417 | 20 | 435.8 | 643.8 | 1.67492 | 1.63498 | 1.51309 | 1.49392 |
| EM | | | | | | | | |
| Industries | MLC-6466 | 20 | 435.8 | 643.8 | 1.65140 | 1.61591 | 1.50391 | 1.48738 |
| EM | | | | | | | | |
| Industries | MLC-6608 | 20 | 435.8 | 643.8 | 1.57654 | 1.55512 | 1.48533 | 1.47394 |
| EM | | | | | | | | |
| Industries | MLC-7700-000 | 20 | 435.8 | 643.8 | 1.57889 | 1.55614 | 1.48480 | 1.47066 |
| EM | | | | | | | | |
| Industries | MLC-7700-100 | 20 | 435.8 | 643.8 | 1.62688 | 1.59547 | 1.50017 | 1.48328 |
| EM | | | | | | | | |
| Industries | MLC-7800-000 | 20 | 435.8 | 643.8 | 1.57961 | 1.55766 | 1.48821 | 1.47347 |
| EM | | | | | | | | |
| Industries | MLC-7800-100 | 20 | 435.8 | 643.8 | 1.63242 | 1.60077 | 1.50575 | 1.48817 |
| EM | | | | | | | | |
| Industries | MLC-9000-000 | 20 | 435.8 | 643.8 | 1.57681 | 1.55503 | 1.48288 | 1.46880 |
| EM | | | | | | | | |
| Industries | MLC-9000-100 | 20 | 435.8 | 643.8 | 1.62463 | 1.59379 | 1.49901 | 1.48237 |
| EM | | | | | | | | |
| Industries | MLC-9100-000 | 20 | 435.8 | 643.8 | 1.57679 | 1.55489 | 1.48512 | 1.47070 |
| EM | | | | | | | | |
| Industries | MLC-9100-100 | 20 | 435.8 | 643.8 | 1.62812 | 1.59690 | 1.50341 | 1.48569 |
| EM | | | | | | | | |
| Industries | MLC-9200-000 | 20 | 435.8 | 643.8 | 1.58049 | 1.55823 | 1.48892 | 1.47482 |
| EM | | | | | | | | |
| Industries | MLC-9200-100 | 20 | 435.8 | 643.8 | 1.63400 | 1.60198 | 1.50711 | 1.48961 |
| EM | | | | | | | | |
| Industries | MLC-9300-000 | 20 | 435.8 | 643.8 | 1.57985 | 1.55820 | 1.48258 | 1.46883 |
| EM | | | | | | | | |
| Industries | MLC-9300-100 | 20 | 435.8 | 643.8 | 1.62638 | 1.59610 | 1.51 950 | 1.50281 |
| EM | | | | | | | | |
| Industries | MLC-9400-000 | 20 | 435.8 | 643.8 | 1.58667 | 1.56252 | 1.49064 | 1.47436 |
| EM | | | | | | | | |
| Industries | MLC-9400-100 | 20 | 435.8 | 643.8 | 1.63150 | 1.60089 | 1.50511 | 1.48798 |
| | nCPS + nCPAC | | | | | | | |
| Schirmer | PS | 30 | 435.8 | 643.8 | 1.73946 | 1.68698 | 1.54571 | 1.52110 |
| | nCPS + nCPAC | | | | | | | |
| Schirmer | PS | 50 | 435.8 | 643.8 | 1.70410 | 1.65745 | 1.54718 | 1.52225 |
| EM | | | | | | | | |
| Industries | ZLI-1083 | 20 | 435.8 | 643.8 | 1.63900 | 1.60709 | 1.50520 | 1.48743 |
| EM | | | | | | | | |
| Industries | ZLI-1132 | 20 | 435.8 | 643.8 | 1.66554 | 1.62743 | 1.50920 | 1.49127 |
| EM | | | | | | | | |
| Industries | ZLI-1565 | 20 | 435.8 | 643.8 | 1.65420 | 1.61779 | 1.51371 | 1.49426 |
| EM | | | | | | | | |
| Industries | ZLI-1694 | 20 | 435.8 | 643.8 | 1.66202 | 1.62343 | 1.51740 | 1.49800 |
| EM | | | | | | | | |
| Industries | ZLI-1840 | 20 | 435.8 | 643.8 | 1.67388 | 1.63375 | 1.51179 | 1.49348 |
| EM | | | | | | | | |
| Industries | ZLI-1957S | 20 | 435.8 | 643.8 | 1.65762 | 1.61817 | 1.51955 | 1.49899 |
| EM | | | | | | | | |
| Industries | ZLI-2081 | 20 | 435.8 | 643.8 | 1.64303 | 1.60693 | 1.51773 | 1.49696 |
| EM | | | | | | | | |
| Industries | ZLI-2116-000 | 20 | 435.8 | 643.8 | 1.65590 | 1.61846 | 1.51725 | 1.49777 |
| EM | | | | | | | | |
| Industries | ZLI-2140-100 | 20 | 435.8 | 643.8 | 1.66875 | 1.62511 | 1.51927 | 1.49859 |
| EM | | | | | | | | |
| Industries | ZLI-2222-100 | 20 | 435.8 | 643.8 | 1.63727 | 1.60305 | 1.51762 | 1.49794 |
| EM | | | | | | | | |
| Industries | ZLI-2244-100 | 20 | 435.8 | 643.8 | 1.56717 | 1.54828 | 1.48838 | 1.47577 |
| EM | | | | | | | | |
| Industries | ZLI-2293 | 20 | 435.8 | 643.8 | 1.66398 | 1.62612 | 1.51517 | 1.49595 |
| EM | | | | | | | | |
| Industries | ZLI-2359 | 20 | 435.8 | 643.8 | 1.53286 | 1.51820 | 1.47885 | 1.46631 |
| EM | | | | | | | | |
| Industries | ZLI-2419 | 20 | 435.8 | 643.8 | 1.68559 | 1.64030 | 1.53075 | 1.50222 |
| EM | | | | | | | | |
| Industries | ZLI-2452 | 20 | 435.8 | 643.8 | 1.67209 | 1.63049 | 1.51826 | 1.49737 |
| EM | | | | | | | | |
| Industries | ZLI-2471 | 20 | 435.8 | 643.8 | 1.67199 | 1.63044 | 1.51826 | 1.49737 |
| EM | | | | | | | | |
| Industries | ZLI-2772 | 20 | 435.8 | 643.8 | 1.65611 | 1.61824 | 1.51690 | 1.49794 |
| EM | | | | | | | | |
| Industries | ZLI-2788-000 | 20 | 435.8 | 643.8 | 1.65875 | 1.62118 | 1.51923 | 1.49982 |
| EM | | | | | | | | |
| Industries | ZLI-2788-100 | 20 | 435.8 | 643.8 | 1.67789 | 1.63369 | 1.52521 | 1.50250 |
| EM | | | | | | | | |
| Industries | ZLI-2861 | 20 | 435.8 | 643.8 | 1.64778 | 1.61057 | 1.51758 | 1.49717 |
| EM | | | | | | | | |
| Industries | ZLI-2903 | 20 | 435.8 | 643.8 | 1.65472 | 1.61754 | 1.51494 | 1.49531 |
| EM | | | | | | | | |
| Industries | ZLI-2950 | 20 | 435.8 | 643.8 | 1.66655 | 1.62713 | 1.51659 | 1.49585 |
| EM | | | | | | | | |
| Industries | ZLI-3021-000 | 20 | 435.8 | 643.8 | 1.59166 | 1.56644 | 1.49315 | 1.47925 |
| EM | | | | | | | | |
| Industries | ZLI-3021-100 | 20 | 435.8 | 643.8 | 1.58529 | 1.56059 | 1.49309 | 1.47663 |
| EM | | | | | | | | |
| Industries | ZLI-3054-000 | 20 | 435.8 | 643.8 | 1.60928 | 1.58047 | 1.49989 | 1.48196 |
| EM | | | | | | | | |
| Industries | ZLI-3054-100 | 20 | 435.8 | 643.8 | 1.60854 | 1.57932 | 1.50044 | 1.48227 |
| EM | | | | | | | | |
| Industries | ZLI-3092-000 | 20 | 435.8 | 643.8 | 1.62676 | 1.59493 | 1.50723 | 1.48803 |
| EM | ZLI-3092-100 | 20 | 435.8 | 643.8 | 1.62807 | 1.59612 | 1.50448 | 1.49062 |
| Industries | | | | | | | | |
| EM | | | | | | | | |
| Industries | ZLI-3103 | 20 | 435.8 | 643.8 | 1.56739 | 1.54507 | 1.48833 | 1.47185 |
| EM | | | | | | | | |
| Industries | ZLI-3145 | 20 | 435.8 | 643.8 | 1.67196 | 1.63016 | 1.52100 | 1.49960 |
| EM | | | | | | | | |
| Industries | ZLI-3187 | 20 | 435.8 | 643.8 | 1.66284 | 1.62219 | 1.51775 | 1.49518 |
| EM | | | | | | | | |
| Industries | ZLI-3201-000 | 20 | 435.8 | 643.8 | 1.68052 | 1.62329 | 1.51117 | 1.49282 |
| EM | | | | | | | | |
| Industries | ZLI-3201-100 | 20 | 435.8 | 643.8 | 1.66473 | 1.62603 | 1.51660 | 1.49780 |
| EM | | | | | | | | |
| Industries | ZLI-3225 | 20 | 435.8 | 643.8 | 1.67127 | 1.63396 | 1.52106 | 1.50017 |
| EM | | | | | | | | |
| Industries | ZLI-3239 | 20 | 435.8 | 643.8 | 1.67885 | 1.63662 | 1.51798 | 1.49681 |
| EM | | | | | | | | |
| Industries | ZLI-3244 | 20 | 435.8 | 643.8 | 1.68629 | 1.62832 | 1.51995 | 1.50042 |
| EM | | | | | | | | |
| Industries | ZLI-3262 | 20 | 435.8 | 643.8 | 1.67472 | 1.62888 | 1.52241 | 1.49884 |
| EM | | | | | | | | |
| Industries | ZLI-3276-000 | 20 | 435.8 | 643.8 | 1.61518 | 1.58501 | 1.50054 | 1.48427 |
| EM | | | | | | | | |
| Industries | ZLI-3276-100 | 20 | 435.8 | 643.8 | 1.60803 | 1.57821 | 1.50056 | 1.48156 |
| EM | | | | | | | | |
| Industries | ZLI-3279 | 20 | 435.8 | 643.8 | 1.58417 | 1.55823 | 1.49269 | 1.47558 |
| EM | | | | | | | | |
| Industries | ZLI-3285 | 20 | 435.8 | 643.8 | 1.66925 | 1.62837 | 1.52134 | 1.50100 |
| EM | | | | | | | | |
| Industnes | ZLI-34119 | 20 | 435.8 | 643.8 | 1.54032 | 1.52389 | 1.48164 | 1.46910 |
| EM | | | | | | | | |
| Industries | ZLI-3412-000 | 20 | 435.8 | 643.8 | 1.57761 | 1.55420 | 1.49168 | 1.47587 |
| EM | | | | | | | | |
| Industries | ZLI-3412-100 | 20 | 435.8 | 643.8 | 1.57551 | 1.55280 | 1.49149 | 1.47600 |
| EM | | | | | | | | |
| Industries | ZLI-3417-000 | 20 | 435.8 | 643.8 | 1.66926 | 1.62800 | 1.51487 | 1.49528 |
| EM | | | | | | | | |
| Industries | ZLI-3417-100 | 20 | 435.8 | 643.8 | 1.66174 | 1.62195 | 1.51454 | 1.49447 |
| EM | | | | | | | | |
| Industries | ZLI-3449-000 | 20 | 435.8 | 643.8 | 1.65849 | 1.62030 | 1.51544 | 1.49461 |
| EM | | | | | | | | |
| Industries | ZLI-3449-100 | 20 | 435.8 | 643.8 | 1.66638 | 1.62679 | 1.51858 | 1.49806 |
| EM | | | | | | | | |
| Industries | ZLI-3502 | 20 | 435.8 | 643.8 | 1.69061 | 1.64520 | 1.52527 | 1.50421 |
| EM | | | | | | | | |
| Industries | ZLI-3546 | 20 | 435.8 | 643.8 | 1.62607 | 1.59396 | 1.50289 | 1.48578 |
| EM | | | | | | | | |
| Industries | ZLI-3561-000 | 20 | 435.8 | 643.8 | 1.58430 | 1.55792 | 1.49252 | 1.47696 |
| EM | | | | | | | | |
| Industries | ZLI-3561-100 | 20 | 435.8 | 643.8 | 1.58839 | 1.56277 | 1.49728 | 1.47979 |
| EM | | | | | | | | |
| Industries | ZLI-3695-000 | 20 | 435.8 | 643.8 | 1.64775 | 1.61169 | 1.51323 | 1.49452 |
| EM | | | | | | | | |
| Industries | ZLI-3695-100 | 20 | 435.8 | 643.8 | 1.68243 | 1.63685 | 1.52615 | 1.49995 |
| EM | | | | | | | | |
| Industries | ZLI-3700-000 | 20 | 435.8 | 643.8 | 1.61130 | 1.58091 | 1.51924 | 1.50205 |
| EM | | | | | | | | |
| Industries | ZLI-3700-100 | 20 | 435.8 | 643.8 | 1.60684 | 1.57913 | 1.49987 | 1.48374 |
| EM | | | | | | | | |
| Industries | ZLI-3701-000 | 20 | 435.8 | 643.8 | 1.60884 | 1.57913 | 1.49987 | 1.48374 |
| EM | | | | | | | | |
| Industries | ZLI-3701-100 | 20 | 435.8 | 643.8 | 1.60894 | 1.57966 | 1.50039 | 1.48484 |
| EM | | | | | | | | |
| Industries | ZLI-3946 | 20 | 435.8 | 643.8 | 1.65068 | 1.60626 | 1.51176 | 1.49108 |
| EM | | | | | | | | |
| Industries | ZLI-3949 | 20 | 435.8 | 643.8 | 1.68022 | 1.63752 | 1.51960 | 1.49874 |
| EM | | | | | | | | |
| Industries | ZLI-3950 | 20 | 435.8 | 643.8 | 1.67115 | 1.63173 | 1.51767 | 1.49780 |
| EM | | | | | | | | |
| Industries | ZLI-3961 | 20 | 435.8 | 643.8 | 1.67548 | 1.63280 | 1.51909 | 1.49808 |
| EM | | | | | | | | |
| Industries | ZLI-3967 | 20 | 435.8 | 643.8 | 1.66866 | 1.62859 | 1.52009 | 1.50016 |
| EM | | | | | | | | |
| Industries | ZLI-3978 | 20 | 435.8 | 643.8 | 1.60710 | 1.57671 | 1.49725 | 1.47978 |
| EM | | | | | | | | |
| Industries | ZLI-4204-000 | 20 | 435.8 | 643.8 | 1.64293 | 1.60954 | 1.50730 | 1.49024 |
| EM | | | | | | | | |
| Industries | ZLI-4204-100 | 20 | 435.8 | 643.8 | 1.68708 | 1.64575 | 1.51619 | 1.49750 |
| EM | | | | | | | | |
| Industries | ZLI-4206 | 20 | 435.8 | 643.8 | 1.68478 | 1.63728 | 1.51896 | 1.49709 |
| EM | | | | | | | | |
| Industries | ZLI-4214 | 20 | 435.8 | 643.8 | 1.65901 | 1.62249 | 1.51190 | 1.49407 |
| EM | | | | | | | | |
| Industries | ZLI-4245-000 | 20 | 435.8 | 643.8 | 1.66580 | 1.62511 | 1.51146 | 1.49268 |
| EM | | | | | | | | |
| Industries | ZLI-4245-100 | 20 | 435.8 | 643.8 | 1.66076 | 1.62259 | 1.51605 | 1.49614 |
| EM | | | | | | | | |
| Industries | ZLI-4246-000 | 20 | 435.8 | 643.8 | 1.66076 | 1.62259 | 1.51605 | 1.49614 |
| EM | | | | | | | | |
| Industries | ZLI-4246-100 | 20 | 435.8 | 643.8 | 1.66379 | 1.62582 | 1.51831 | 1.49864 |
| EM | | | | | | | | |
| Industries | ZLI-4277-000 | 20 | 435.8 | 643.8 | 1.64483 | 1.61084 | 1.51343 | 1.49521 |
| EM | | | | | | | | |
| Industries | ZLI-4425 | 20 | 435.8 | 643.8 | 1.69970 | 1.65446 | 1.52487 | 1.50495 |
| EM | | | | | | | | |
| Industries | ZLI-4430 | 20 | 435.8 | 643.8 | 1.67451 | 1.63593 | 1.51881 | 1.49816 |
| EM | | | | | | | | |
| Industries | ZLI-4431 | 20 | 435.8 | 643.8 | 1.70984 | 1.66133 | 1.52273 | 1.50158 |
| EM | ZLI-4469-000 | 20 | 435.8 | 643.8 | 1.67975 | 1.63681 | 1.51041 | 1.49058 |
| Industries | | | | | | | | |
| EM | | | | | | | | |
| Industries | ZLI-4470 | 20 | 435.8 | 643.8 | 1.61026 | 1.58092 | 1.49879 | 1.48265 |
| EM | | | | | | | | |
| Industries | ZLI-4540 | 20 | 435.8 | 643.8 | 1.67279 | 1.63319 | 1.51210 | 1.49373 |
| EM | | | | | | | | |
| Iridustries | ZLI-4596 | 20 | 435.8 | 643.8 | 1.66243 | 1.62417 | 1.51256 | 1.49357 |
| EM | | | | | | | | |
| Industries | ZLI-4619-000 | 20 | 435.8 | 643.8 | 1.59612 | 1.56848 | 1.49439 | 1.47776 |
| EM | | | | | | | | |
| Industries | ZLI-4619-100 | 20 | 435.8 | 643.8 | 1.58303 | 1.55885 | 1.49745 | 1.48171 |
| EM | | | | | | | | |
| Industries | ZLI-4620 | 20 | 435.8 | 643.8 | 1.65778 | 1.62274 | 1.51016 | 1.49252 |
| EM | | | | | | | | |
| Industries | ZLI-4705-000 | 20 | 435.8 | 643.8 | 1.60653 | 1.57834 | 1.49920 | 1.48273 |
| EM | | | | | | | | |
| Industries | ZLI-4718 | 20 | 435.8 | 643.8 | 1.58233 | 1.55999 | 1.49208 | 1.47535 |
| EM | | | | | | | | |
| Industries | ZLI-4720-000 | 20 | 435.8 | 643.8 | 1.65339 | 1.61791 | 1.50946 | 1.48965 |
| EM | | | | | | | | |
| Industries | ZLI-4720-100 | 20 | 435.8 | 643.8 | 1.65322 | 1.61805 | 1.50867 | 1.49097 |
| EM | | | | | | | | |
| Industries | ZLI-5049-100 | 20 | 435.8 | 643.8 | 1.76740 | 1.69756 | 1.52406 | 1.50799 |
| EM | | | | | | | | |
| Industries | ZLI-5070 | 20 | 435.8 | 643.8 | 1.67344 | 1.63550 | 1.51791 | 1.49959 |
| EM | | | | | | | | |
| Industries | ZLI-5100-000 | 20 | 435.8 | 643.8 | 1.63681 | 1.60560 | 1.50432 | 1.48800 |
| EM | | | | | | | | |
| Industries | ZLI-5100-100 | 20 | 435.8 | 643.8 | 1.71530 | 1.66632 | 1.51763 | 1.49957 |
| EM | | | | | | | | |
| Industries | ZLI-5400-000 | 20 | 435.8 | 643.8 | 1.61610 | 1.58728 | 1.49973 | 1.48276 |
| EM | | | | | | | | |
| Industries | ZLI-5400-100 | 20 | 435.8 | 643.8 | 1.72016 | 1.66758 | 1.52431 | 1.50187 |
| EM | | | | | | | | |
| Industries | ZLI-5500-000 | 20 | 435.8 | 643.8 | 1.62170 | 1.58979 | 1.49933 | 1.48108 |
| EM | | | | | | | | |
| Industries | ZLI-5500-100 | 20 | 435.8 | 643.8 | 1.71517 | 1.66290 | 1.52039 | 1.49791 |

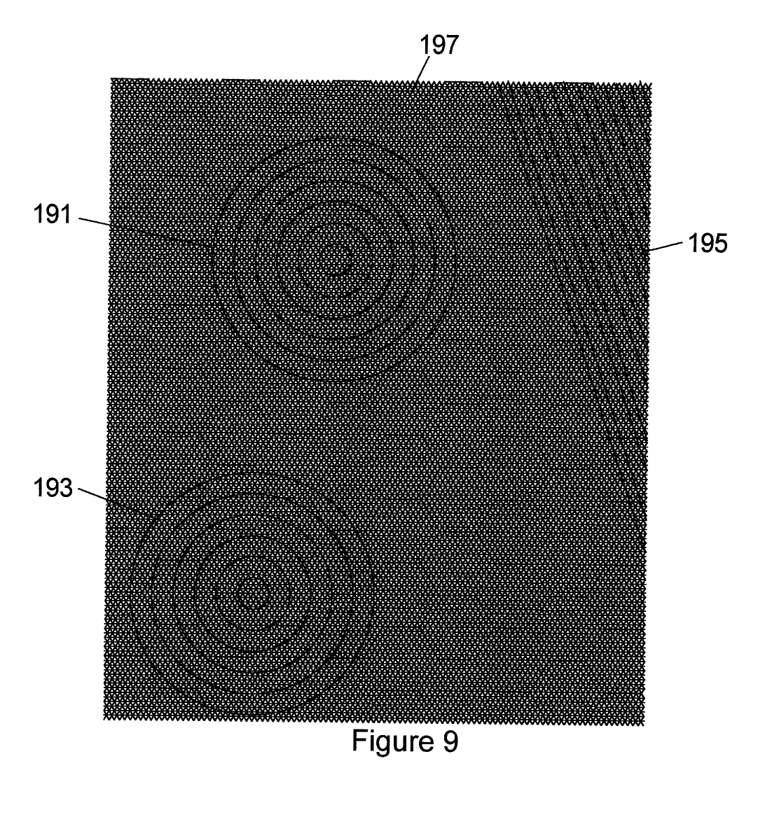

FIG. 9 illustrates that, using the present art, several lens and prism zones can be present simultaneously on the same window. The variable net refraction achievable by the present invention may be arranged in parallel lines to form prism arrays or in concentric circle arrays to form lenses. 191 is a first lens zone formed by concentric circles. It consists of two arrayed gradient materials in series similar to that described in FIG. 8. 193 is a second concurrent lens zone. 195 is a concurrent prism zone, it consists of parallel refractive gradients such as are described in FIG. 7 (except that two FIG. 7 arrays are used in series to achieve achromatic refraction). Areas of the window not covered by any of these zones produce no net refraction. A user looking through this window will see some objects magnified by the 191 and 193 lenses, some objects bent into view by the 195 achromatic prism section, and objects visible from the non-activated sections of the window will appear normal (at their true position and not magnified).

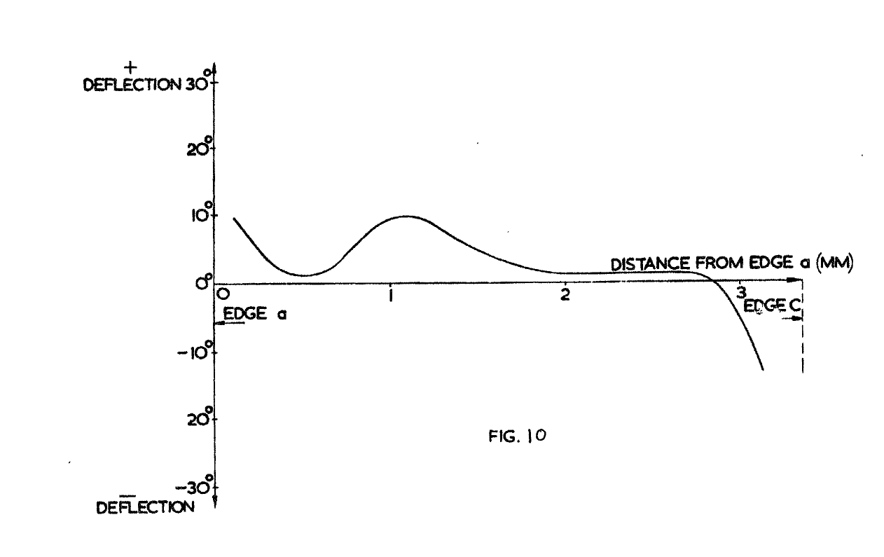

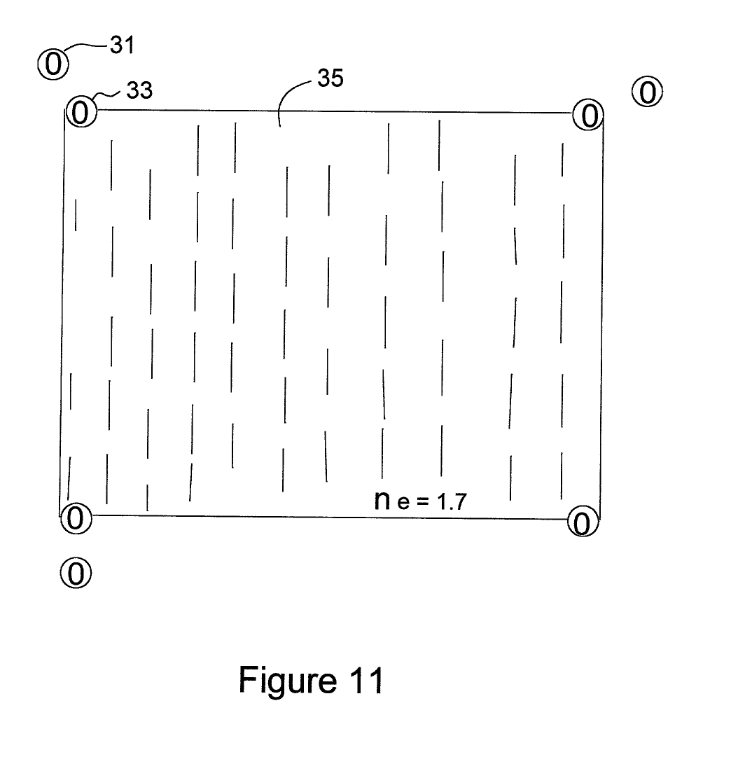

FIG. 10 prior art is a graph of the deflection achieved across the prior art (Frey) cell. Obviously, the deflection varies from ten degrees to zero degrees across the cell. The present invention creates a much more consistent and even deflection across the cell. This is best illustrated in the one of the preferred embodiments illustrated in FIGS. 11 through 17.

FIG. 11 shows the present invention in a first state. A 35 electro-optic material such as a liquid crystal cell is aligned to have a constant refractive index of 1.7. The circles such as 31 and 33 are transparent electrodes which currently are in neutral states. No electric field is acting upon the 35 liquid crystal.

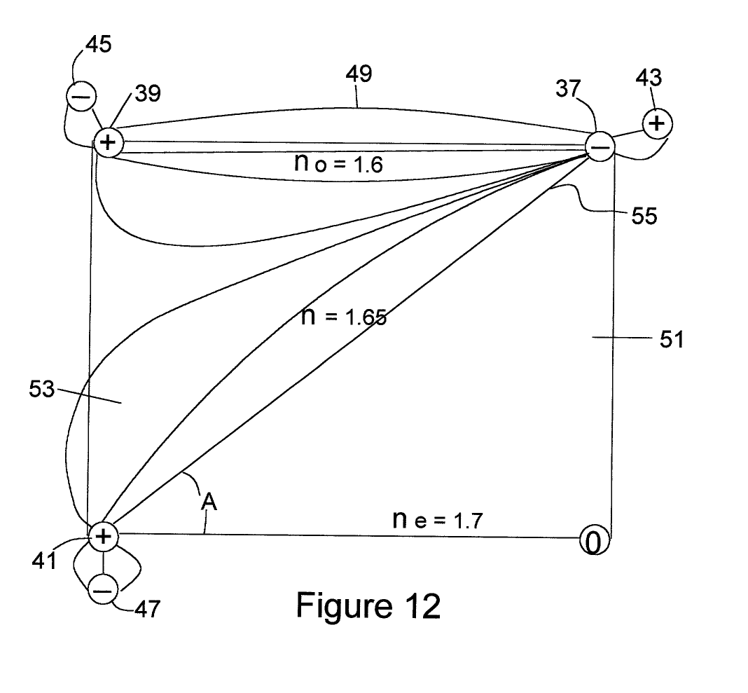

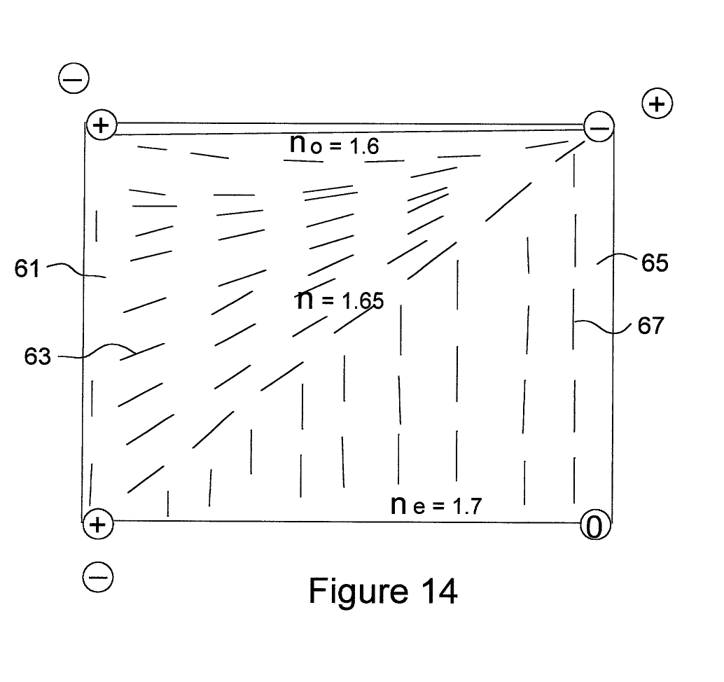

FIG. 12 is the same cell as FIG. 11 except now some of the transparent electrodes have been activated with electric charges. The charges in 37, 39, and 41 create an electric field depicted by lines such as 49. This field affects the liquid crystal 53 as described later. Note that a second series of electric charges have also been initiated such as 43, 45, and 47 these are referred to as trimming charges. Each of these charges also creates a corresponding electric field in conjunction with one each of the aforementioned 37, 39, and 47 charges respectively. The fields created by the trimming charges ensures that the electric field directed through the liquid crystal 53 in a desired manner and that they are not directed through an undisturbed area 51 section of the liquid crystal. A line 55 has been drawn in to illustrate a dividing point between the disturbed region of the liquid crystal 53 and the undisturbed region of the liquid crystal 51. Note that the refractive index at line 55 is equal to the average of the ηₑ and ηₒ refractive indices (assuming that the 55 line is at an angle “A” of 0.7854 radians—see equation described under FIG. 14).

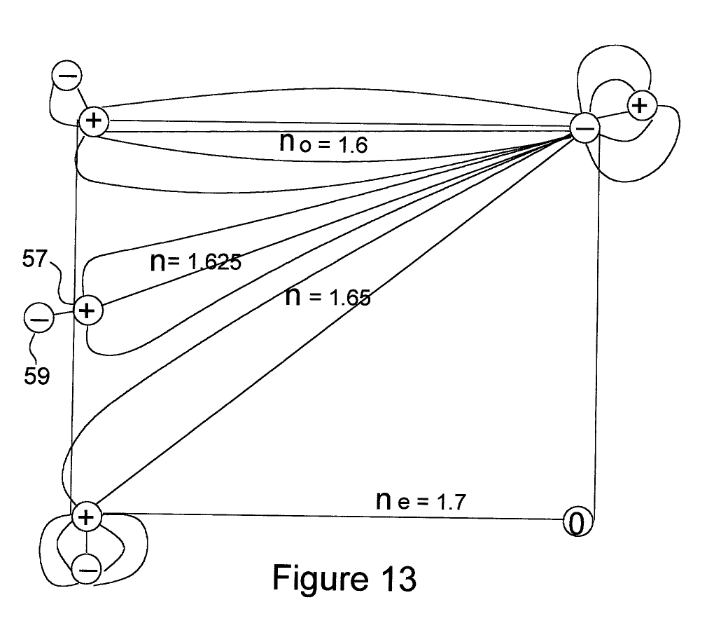

FIG. 13 depicts that additional charges such as 57 and trimming charges such as 59 can be added to improve precision of the electric field in the system.

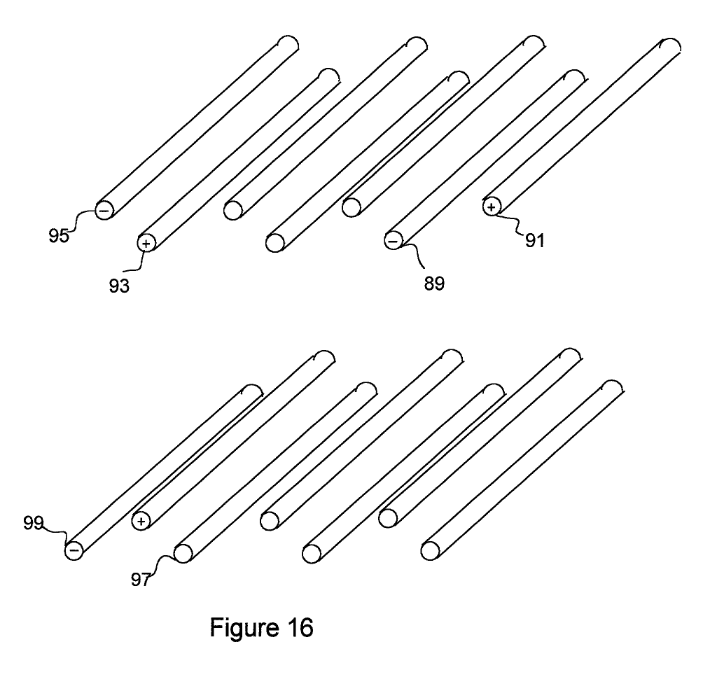

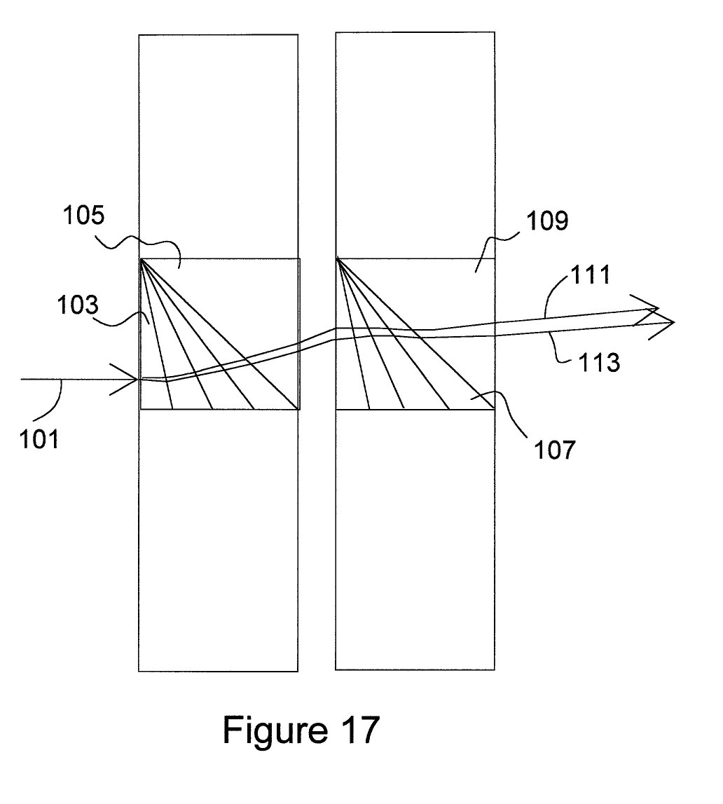

FIG. 14 represents the crystal alignment corresponding to the electric fields of FIG. 12. A first region of the liquid crystal forms a gradient index prism with the charged crystals reliably aligning with the electric fields of FIG. 12 and pointing to the negative electrode. 63 represents one such aligned crystal. The refractive index gradient is reliably produced according to the angle “A” of FIG. 12 and between a first state [symbol] o=1.6 and a a mid index AvgMat=(off2//(0.5*Pi))*Mat2LS2+(1−(Off2/(0.5*Pi)))*Mat2L calculated by the latter discussed PreHalfGradOpT software included herein. (Plugging in the variables of the present example such as A=0.7854 yields AvgMat=(0.7854/(0.5*3.1416))*1.6+(1−(0.7854/(0.5*3.1416)))*1.7=1.65. The undisturbed region of the liquid crystal 65 retain their original orientation and reliably maintain the ηₑ refractive index of 1.7. By varying the angle “A” of FIG. 12, the gradient index and net refractive index are reliably and predictably varied. FIG. 17 illustrates this process of producing half cell gradients in two liquid crystal materials in series.

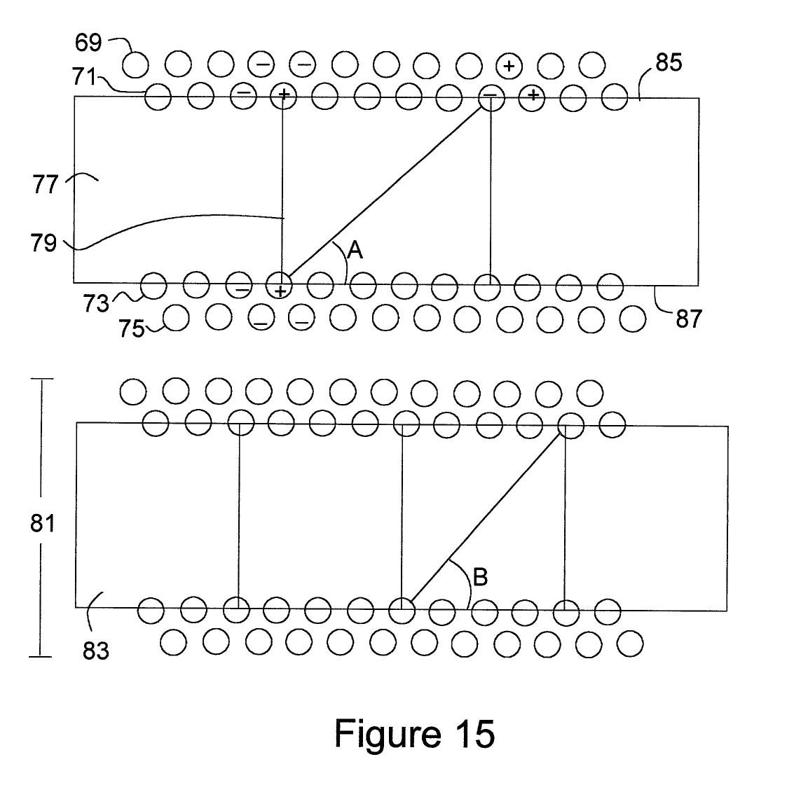

FIG. 15 illustrates that the art of the present invention utilizing cells of FIG. 14 in series to reliably refract light while minimizing dispersion. Also the cells of FIG. 15 are arrayed (here only three are shown, in practice there are many thousands of cells arrayed in vast arrays). 69 illustrates a row of trimming charges, some of the cells are currently carring charges. A second row 71 consists of charges that create fields effecting the liquid crystal and also of trimming charges. Note that these trimming charges prevent region 71 from being effected by the electric fields. The line at 79 is not a structure it is included only to illustrate the previously defined regions from one another. The line at 85 is representative of a solid substrate in which the transparent electrodes reside. Note that the electric charge forms a first angle “A” (the same as previously discussed). “A” represents the border between regions in the liquid crystal created by the electric field. Note that by varying the electrodes that create the electric field, the angle of “A” can be varied. Varying the angle “A” causes the refraction and the dispersion of the cell to vary (it is note worthy that the width of the cell also varies. The term cell as used herein is by definition the liquid crystal that resides between two normals drawn from the electrodes at each end of the line describing “A”. The second liquid crystal array 81 consists of a second liquid crystal material. The angle “B” too is crated by electric fields. It too delineates the division between the gradient refractive index area and the homogenous refractive index areas. The angles of A and B operate in conjunction with one another in series to create a desired net refraction with minimized dispersion. The PreHalfGradOpT software described later calculates the necessary angles according to each materials respective characteristics. Electrodes which will produce these angles are then selected by the software and charged accordingly and alternately to minimize crosstalk as discussed in the first embodiment.

FIG. 16 is intended to illustrate that the cells are three dimensional. The electrodes are depicted as charged bars. 89, 93, and 97 form the electric field in the liquid crystal while 91, 95, and 99 trim the field to ensure it doesn't affect areas which are to remain undisturbed. The art to drive this matrix of electrodes, though complex, is well known to those skilled in the art and therefore not fully described herein. The PreHalfradOpT software included herein determines what angles and therefore electrodes must be activated to create the desired net refraction with minimized dispersion.

FIG. 17 illustrates light passing through an array of the present invention in series. Polychromatic light 101 is incident upon one cell in the first array of cells. As the light goes through the first gradient refractive index region 103 of the first material it bends unevenly and is split into its constituent frequencies. It then passes through the homogenous region of the first material array 105. The light passes through a cell in the array consisting of the gradient area of the second material 107. It then passes through the homogenous region 109 of the second material in the array. The angles chosen by the computer software and created by corresponding electrodes which produce the electric fields and predictable crystal alignment cause the light to emerge from the array series with its constituents frequencies nearly parallel (achromatic). Thus a first color 111 and a second color 113 are deflected at the same angle achromatically. The achromatic lens and achromatic prism arrays of FIG. 9 can be achieved with this methodology. The concentric circle gradient array lens structure of FIG. 8 can be achieved with this structure (accept that only half of each material has a refractive gradient whereas all of the material is gradient in the FIG. 8 discussion and it accompanying PreGradOpT software).

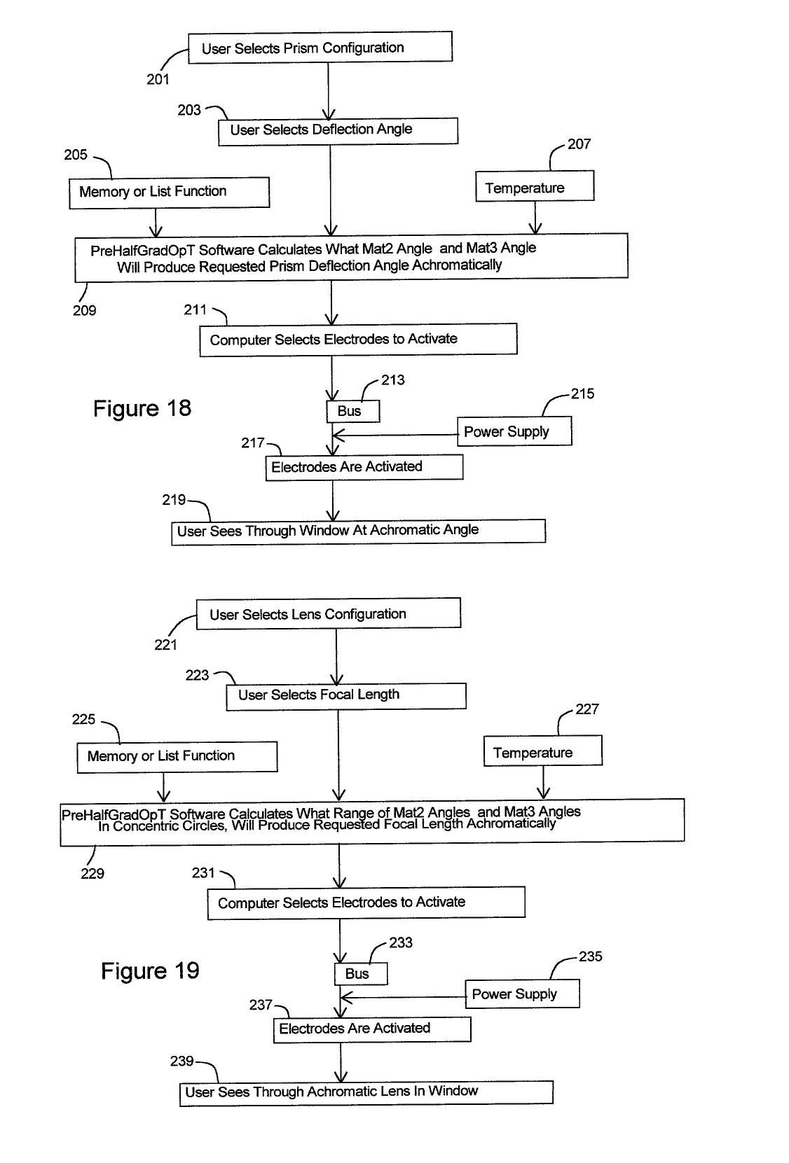

FIG. 18 is a self-explanatory flowchart depicting electrooptic operation of a deflecting zone. Temperature 207 of the liquid crystal is used as an input when calculating how to achieve the requested deflection angle with minimized dispersion. Refractive indices or other values can be recalled from memory 205. This flowchart also describes operation of the first embodiment depicted herein using the PreGradOpT software (instead of the PreHalfGradOpT software).

FIG. 19 is a self-explanatory flowchart depicting electrooptic operation of a magnifying zone. This flowchart also describes operation of the first embodiment depicted herein using the PreGradOpT software (instead of the PreHalfGradOpT software).

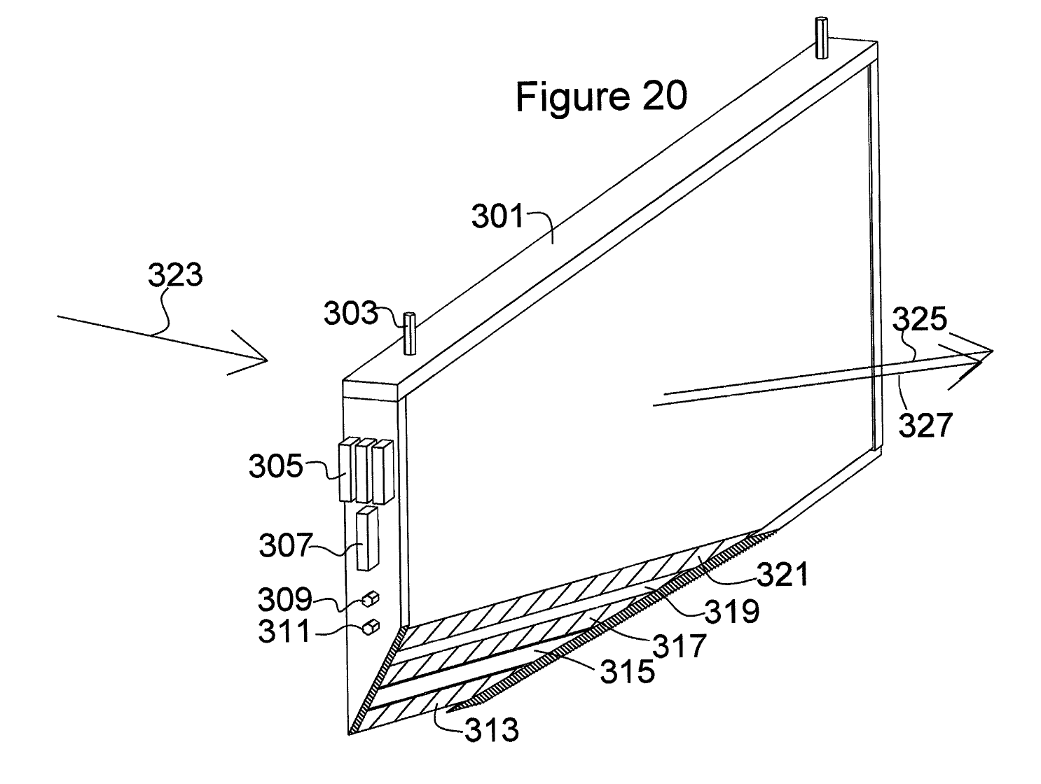

FIG. 20 is an assembled electrooptic window deflecting a polychromatic ray achromatically. A first multipin electrode jack 305 carries electric current to selected transparent electrodes in the first substrate 313. The electrodes receiving current from 305 are mated with electrodes receiving current from a second multipin jack 307 interfacing with electrodes on one side of second substrate 317 such that gradient refractive zones are created in the first material 315. Similar multipin jacks supply current to select electrodes on the second side of substrate 317 which are mated with select electrodes in substrate 321 such that gradient refractive zones are produced in a second material 319. The gradients of the 315 material and the 319 material in series cause a polychromatic incident ray 323 to exit the series on parallel trajectories as a first frequency ray 325 and a second frequency ray 327. A temperature monitoring jack 309 conveys the temperature reading of the liquid crystals to the computer controller. A temperature controlling jack 311 (connecting to a heating coil within the 317 substrate) enables the liquid crystal temperature to be maintained within an operating range. The entire series is sealed with a frame work 301 which has mounting bolts similar to 303 affixed thereto. This unit can be mounted within the wall of a building.

TABLE IV lists the PreHalfGradOpT mathematical logic of the second embodiment herein. It is used to calculate trajectories of two frequencies of light through the two electro-optic materials. Each of said electro-optic materials forming a gradient index prism operating between its respective ηₑ and ηₒ states at respective angles that can be varied. Thereby producing variable net achromatic refraction. Note that angle “A” previously referenced is represented by Off2 in the first liquid crystal and Off3 in the second liquid crystal. The below logic does not consider whether the polar axis differs from the pair of optical axis in which case an additional variable is required to calculate offset angles required to compensate for the differences in axis.

Ref1 = asin (sin (Inc1) /Mat2L) ;
AvgMat = (fabs (Off2) / (0.5*PI) ) *Mat2LS2+ (1-

(fabs (Off2) / (0.5*PI) ) ) *Mat2L;

GradOff = Off2/2;
x = Mat2L*sin (Ref1+GradOff) /AvgMat;
if (fabs (x) <=1)

Ref2 = asin (x) ;

else

Nan = true;

x = sin (Inc1) /Mat2L;
if (fabs (x) <=1)

Ref1a = asin (x) ;

else

Nan = true;

MatGrad = (AvgMat-Mat2L) /3;
x = Mat2L*sin (Ref1a+GradOff/2) / (Mat2L+MatGrad) ;
if (fabs (x) <=1)

Ref2a = asin (x) ;

else

Nan = true;

x =

(Mat2L+MatGrad) *sin (Ref2a+GradOff/2) / (Mat2L+2*MatGrad) ;

if (fabs (x) <=1)

Ref3ax = asin (x) ;

else

Nan = true;

x =

(Mat2L+2*MatGrad) *sin (Ref3ax+GradOff/2) /AvgMat;

if(fabs (x) <=1)

Ref3a = asin (x) ;

else

Nan = true;

DRef = (Ref3a-Ref2) *GradMult+Ref3a;
x = AvgMat*sin (DRef) /Mat2LS2;
if (fabs (x) <=1)

Ref3 = asin (x) ;

else

Nan = true;

x = Mat2LS2*sin (Ref3-Off2) /Mat3L;
if (fabs (x) <=1)

Ref4L = asin (x) ;

else

Nan = true;

////////////////////////////////////////////////////////////

Ref1 = asin (sin (Inc1) /Mat2H) ;
AvgMat = (fabs (Off2) / (0.5*PI) ) *Mat2HS2+ (1-

(fabs (Off2) / (0.5*PI) ) ) *Mat2H;

x = Mat2H*sin (Ref1+GradOff) /AvgMat;
if (fabs (x) <=1)

Ref2 = asin (x) ;

else

Nan = true;

x = sin (Inc1) /Mat2H;
if (fabs (x) <=1)

Ref1a = asin (x) ;

else

Nan = true;

MatGrad = (AvgMat-Mat2H) /3;
x = Mat2H*sin (Ref1a+GradOff/2) / (Mat2H+MatGrad) ;
if (fabs (x) <=1)

Ref2a = asin (x) ;

else

Nan = true;

x =

(Mat2H+MatGrad) *sin (Ref2a+GradOff/2) / (Mat2H+2*MatGrad) ;

if (fabs (x) <=1)

Ref3ax = asin (x) ;

else

Nan = true;

x =

(Mat2H+2*MatGrad) *sin (Ref3ax+GradOff/2) /AvgMat;

if (fabs (x) <=1)

Ref3a = asin (x) ;

else

Nan = true;

DRef = (Ref3a-Ref2) *GradMult+Ref3a;
x = AvgMat*sin(DRef) /Mat2HS2;
if (fabs (x) <=1)

Ref3 = asin (x) ;

else

Nan = true;

x = Mat2HS2*sin (Ref3-Off2) /Mat3H;
if (fabs (x) <=1)

Ref4H = asin (x) ;

else

Nan = true;

////////////////////////////////////////////////////////////
/

AvgMat = (fabs (Off3) / (0.5*PI) ) *Mat3LS2+ (1-

(fabs (Off3) / (0.5*PI) ) ) *Mat3L;

GradOff = Off3/2;
x = Mat3L*sin (Ref4L+GradOff) /AvgMat;
if (fabs (x) <=1)

Ref2 = asin (x) ;

else

Nan = true;

x = sin (Inc1) /Mat3L;
if (fabs (x) <=1)

Ref1a = asin (x) ;

else

Nan = true;

MatGrad = (AvgMat-Mat3L) /3;
x = Mat3L*sin (Ref4L+GradOff/2) / (Mat3L+MatGrad) ;
if (fabs (x) <=1)

Ref2a = asin (x) ;

else

Nan = true;

x =

(Mat3L+MatGrad) *sin (Ref2a+GradOff/2) / (Mat3L+2*MatGrad) ;

if (fabs (x) <=1)

Ref3ax = asin (x) ;

else

Nan = true;

x =

(Mat3L+2*MatGrad) *sin (Ref3ax+GradOff/2) /AvgMat;

if (fabs (x) <=1)

Ref3a = asin (x) ;

else

Nan = true;

DRef = (Ref3a-Ref2) *GradMult+Ref3a;
x = AvgMat*sin (DRef) /Mat3LS2;
if (fabs (x) <=1)

Ref3 = asin (x) ;

else

Nan = true;

x = Mat3LS2*sin(Ref3-Off3) ;
if (fabs (x)<=1)

FRefL = asin (x) ;

else

Nan = true;

////////////////////////////////////////////////////////////
////

AvgMat = (fabs (Off3) / (0.5*PI) ) *Mat3HS2+ (1-

(fabs (Off3) / (0.5*PI) ) ) *Mat3H;

x = Mat3H*sin (Ref4H+GradOff) /AvgMat;
if (fabs (x) <=1)

Ref2 = asin (x) ;

else

Nan = true;

x = sin (Inc1) /Mat3H;
if (fabs (x) <=1)

Ref1a = asin (x) ;

else

Nan = true;

MatGrad = (AvgMat-Mat3H) /3;
x = Mat3H*sin (Ref4H+GradOff/2) / (Mat3H+MatGrad) ;
if (fabs (x) <=1)

Ref2a = asin (x) ;

else

Nan = true;

x =

(Mat3H+MatGrad) *sin (Ref2a+GradOff/2) / (Mat3H+2*MatGrad) ;

if (fabs (x) <=1)

Ref3ax = asin (x) ;

else

Nan = true;

x =

(Mat3H+2*MatGrad) *sin (Ref3ax+GradOff/2) /AvgMat;

if (fabs (x) <=1)

Ref3a = asin (x) ;

else

Nan = true;

DRef = (Ref3a-Ref2) *GradMult+Ref3a;
x = AvgMat*sin (DRef) /Mat3HS2;
if (fabs (x) <=1)

Ref3 = asin (x) ;

else

Nan = true;

x = Mat3HS2*sin (Ref3-Off3) ;
if (fabs (x) <=1)

FRefH = asin (x) ;

else

Nan = true;

////////////////////////////////////////////////////////////
///////

double Rell;
if (FRefH<0&&FRefL>0| |FRefH>0&&FRefL<0)

Rell = fabs (FRefH) + fabs(FRefL) ;

else

Rell = fabs (FRefH - FRefL) ;

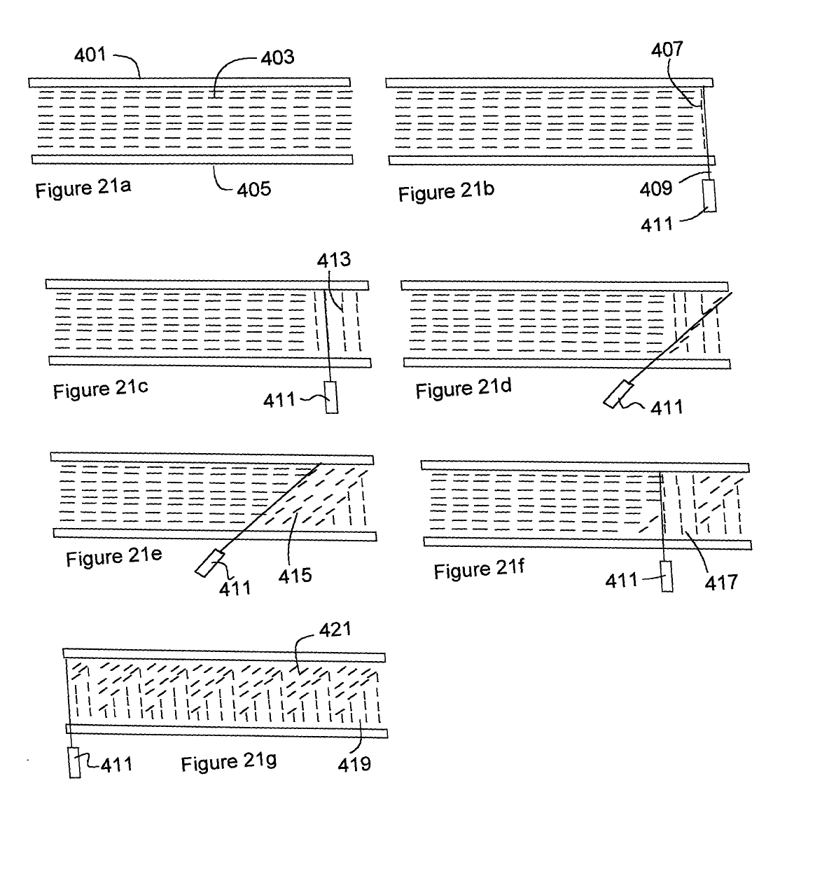

FIG. 21a through FIG. 21g depict a third embodiment of the present invention.

Specifically, they depict an alternate means of addressing a material for use in the present invention. An alternate means of addressing the variable view lens (other than electrically) is desirable since the controlling structures of the electrooptic versions previously discussed may be too complex or imprecise for some applications. Photo addressing of photooptic media is known to those skilled in the art and has been studied most closely particularly in the most recent ten years. FIG. 21a through FIG. 21g depict laser addressing of a photooptic media of the present invention.

FIG. 21a depicts a cell in a first state. A first substrate 401 and a second substrate 405 form two sides enclosing a cell which contains a photo optic media such as a doped liquid crystal 403. In FIG. 21b, a laser 411 with its beam 409 in a first angle begins realigning the liquid crystal in a first realignment 407. In FIG. 21c, the laser 411 has progressed through a portion of the liquid crystal to create a first aligned zone 413. In FIG. 21d, the laser 411 has moved to a different orientation and begun aligning the liquid crystal accordingly. In FIG. 21e, the laser has progressed at the second alignment to create a second realigned zone 415. In FIG. 21f, the laser has resumed the same alignment of FIG. 21b and has realigned a second area 417 similarly to that of 413. In FIG. 21g, the laser has finished addressing the liquid crystal (using a repeated series of the above steps) such that a series of zones with a first alignment and corresponding first refractive index 419 are produced which interface at a precise angle with a series of zones at a second alignment and corresponding second refractive index 421. Phoslo software (Table V) included herein reliably determines the precise angles of alignment that the laser must produce in order to produce the required deflection angle on a polychromatic beam passing through the material and exiting with minimized dispersion. The software (Table V) included herein reliably determines the precise angles of alignment in concentric circles or parallel lines that the laser must produce in order to produce the required range of deflection angles of a polychromatic beam with minimized dispersion with a common focal length or deflection angle.

Though the FIG. 21a through 21g illustrations depict a two dimensional cross section, it will be understood that as the laser beam moves in parallel lines through a three dimensional structure, three dimensional refractive arrayed prism zones are created. Additionally it will be understood that if the laser beam moves through a three dimensional structure in concentric circles, concentric arrays of prism zones are created. By varying the angle from the concentric center of the zone progressively as the laser moves to the outermost concentric circles, a very precise three dimensional lens with a common focal point is created. This is very similar to that describe in FIG. 8 except that in the present embodiment, the resultant prisms are not gradient. The cross section on the FIG. 21a-21g depict only one material in practice two such materials are used in series to create achromatic deflection zones and/or lens zones similar to those depicted in FIG. 9.

TABLE V lists the Phoslo mathematical logic that is used to calculate trajectories of two frequencies of light passing through the two photooptic materials. Each of said photooptic materials forming a prism operating between its respective ηₑ and ηₒ states at respective angles that can be varied. Thereby producing variable net achromatic refraction. Note that angle “A” previously referenced is represented by Off2 in the first liquid crystal and Off3 in the second liquid crystal. The below logic does not consider whether the director axis differs from the pair of optical axis in which case an additional variable is required to calculate offset angles required to compensate for the differences in axis.

AvgMat = (fabs (Off2) / (0.5*PI) ) *Mat2LS2+ (1-

(fabs (Off2) / (0.5*PI) ) ) *Mat2L;

Ref1 = asin (sin (Inc1) /AvgMat) ;
x = AvgMat*sin (Ref1+Off2) /Mat2LS2;
if(fabs (x) <=1)

Ref2 = asin (x) ;

else

Nan = true;

AvgMat = (fabs (Off3) / (0.5*PI) ) *Mat3LS2+ (1-

(fabs (Off3) / (0.5*PI) ) ) *Mat3L;

x = Mat2LS2*sin (Ref2-Off2) /AvgMat;
if (fabs (x) <=1)

Ref3 = asin (x) ;

else

Nan = true;

x = AvgMat*sin (Ret3+Off3) /Mat3LS2;
if (fabs (x) <=1)

Ref4 = asin (x) ;

else

Nan = true;

x = Mat3LS2*sin (Ref4-Off3) ;
if (fabs (x) <=1)

FRefL = asin (x) ;

else

Nan = true;

////////////////////////////////////////////////////////////
////////

AvgMat = (fabs (Off2) / (0.5*PI) ) *Mat2HS2+ (1-

(fabs (Off2) / (0.5*PI) ) ) *Mat2H;

Ref1 = asin (sin (Inc1) /AvgMat) ;
x = AvgMat*sin (Ref1+Off2) /Mat2HS2;
if (fabs (x) <=1)

Ref2 = asin (x) ;

else

Nan = true;

AvgMat = (fabs (Off3) / (0.5*PI) ) *Mat3HS2+ (1-

(fabs (Off3) / (0.5*PI) ) ) *Mat3H;

x = Mat2HS2*sin (Ref2-Off2) /AvgMat;
if (fabs (x) <=1)

Ref3 = asin (x) ;

else

Nan = true;

x = AvgMat*sin (Ref3+Off3) /Mat3HS2;
if (fabs (x) <=1)

Ref4 = asin (x) ;

else

Nan = true;

x = Mat3HS2*sin (Ref4-Off3) ;
if (fabs (x) <=1)

FRefH = asin (x) ;

else

Nan = true;

////////////////////////////////////////////////////////////
///////

double Rell;
if (FRefH<0&&FRefL>0| |FRefH>0&&FRefL<0)

Rell = fabs (FRefH) + fabs (FRefL) ;

else

Rell = fabs(FRefH - FRefL);

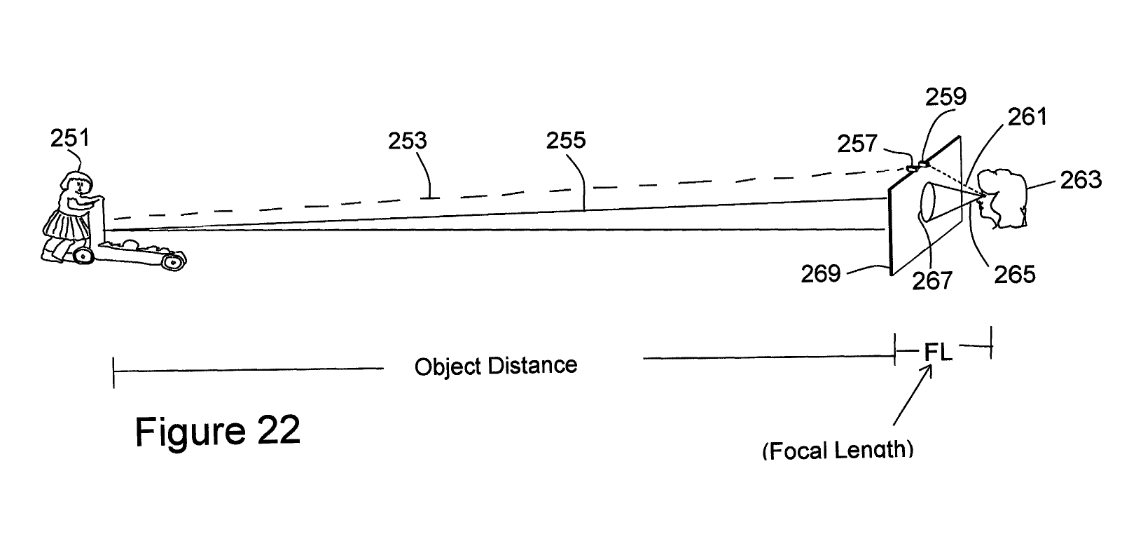

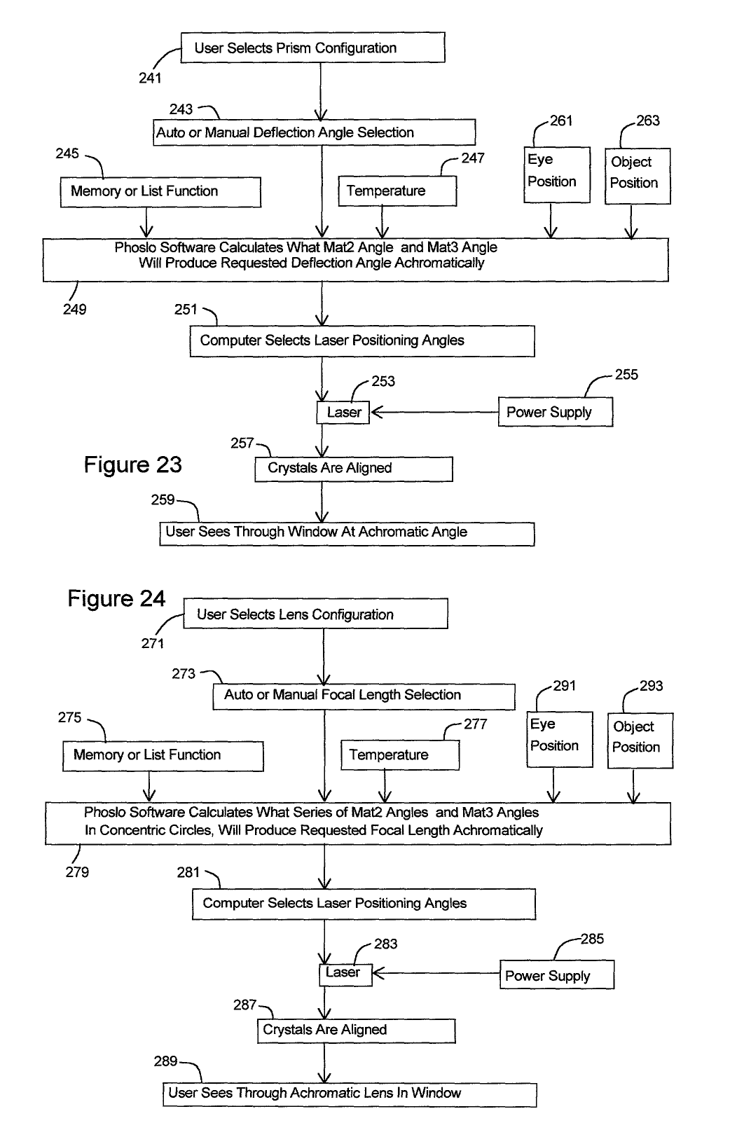

FIG. 22 illustrates an automatically adjusting magnification zone of a variable refractive achromatic window 269 in operation. The user 263 has selected the magnification function and a corresponding zone of concentric circles in array 267 has been produced in the 269 window. The power of this zone is regulated automatically by software which takes input describing the user's eye position (focal length) and an object's distance such as 251. These two inputs are generated using a user infrared sensor 259 and a object infrared sensor 257. Each sensor emits and receives an infrared beam as 261 and 253 respectively. (Other methods of determining distance and position which can be used herein are also know in the art such as cameras and digital optical recognition for example.) Where the information concerning user position and object position enter into the operating software is described in the FIG. 23 and FIG. 24 flowcharts. If the user moves her head or the object 251 position changes, the software changes the magnification power of the 267 zone such that the users view remains in focus. Note that the 267 zone could alternately be a deflection zone in parallel configuration in which case, as the object moves across the horizon, the object's image would remain stationary from the user's perspective and if the user moves horizontally, the objects image would remain stationary from the user's perspective. Either way, polychromatic light from the object 255 passes through the 269 window to emerge as achromatic light 265. This method of automatically keeping magnified objects in focus or lateral objects in view is very useful for watching children, as well as for driving, flying, or piloting ships.

Note that the FIG. 22 means of automatically tracking and responding to user and object position may use any addressing methodology to produce the required prism arrays including electrooptic such as with the first two embodiments herein or photooptic such as with the third embodiment herein, or some other method not discussed herein.

FIG. 23 is a self-explanatory flowchart depicting photooptic operation of a deflecting zone with automatic tracking. Eye position 261 and object position 263 are reported into the operating software.

FIG. 24 is a self-explanatory flowchart depicting photooptic operation of a magnification zone.

TABLE VI illustrates some of the range of achromatic deflection angles for a combination of two materials operating between their Ne and No states at variable transition angles between these states using the three addressing embodiments herein.

| | | | | STATE I | | STATE II | | Constrained |
|---|---|---|---|---|---|---|---|---|
| | | Low | High | Index of | Index of | Index of | Index of | Operating |
| | | Wave- | Wave- | Refraction | Refraction | Refraction | Refraction | Range |
| Source | Material | length | length | MATL ne | MATH ne | MATL no | MATH no | Radians |

PreGradOpT ne then no

| | | | | | | | | | |
|---|---|---|---|---|---|---|---|---|---|
| Mat2 | EM | E49 | 435.8 | 643.8 | 1.87520 | 1.77497 | 1.55631 | 1.52456 | |
| | Industries | | | | | | | | |
| Mat3 | Schirmer | 5nCPS | 435.8 | 643.8 | 1.76642 | 1.70637 | 1.54221 | 1.52784 | −.24 to |
| | | 21 | | | | | | | +.24 |
| Mat2 | Schirmer | nPZPOm | 435.8 | 643.8 | 1.86568 | 1.76542 | 1.53995 | 1.51294 | |
| Mat3 | EM | ZLl- | 435.8 | 643.8 | 1.71530 | 1.66632 | 1.51763 | 1.49957 | −.24 to |
| | Industries | 5100-100 | | | | | | | +.24 |

PreHalfGradOpT ne then no

| | | | | | | | | | |
|---|---|---|---|---|---|---|---|---|---|
| Mat2 | EM | ZLl-2419 | 435.8 | 643.8 | 1.68559 | 1.64030 | 1.53075 | 1.50222 | |
| | Industries | | | | | | | | −.077 to |
| Mat3 | Schirmer | 25 nOPP | 435.8 | 643.8 | 1.85024 | 1.75086 | 1.54561 | 1.51594 | +.077 |
| Mat2 | EM | ZLl-3225 | 435.8 | 643.8 | 1.67127 | 1.63396 | 1.52106 | 1.50017 | |
| | Industries | | | | | | | | −.072 to |
| Mat3 | Schirmer | 21 | 435.8 | 643.8 | 1.86568 | 1.76542 | 1.53995 | 1.51294 | +.072 |
| | | nPZPOm | | | | | | | |

Phoslo ne then no

| | | | | | | | | | |
|---|---|---|---|---|---|---|---|---|---|
| Mat2 | EM | ZLl-2419 | 435.8 | 643.8 | 1.68559 | 1.64030 | 1.53075 | 1.50222 | |
| | Industries | | | | | | | | −.043 to |
| Mat3 | Schirmer | 25 nOPP | 435.8 | 643.8 | 1.85024 | 1.75086 | 1.54561 | 1.51594 | +.043 |
| Mat2 | Schirmer | 15 | 435.8 | 643.8 | 1.72813 | 1.67885 | 1.52473 | 1.50305 | |
| | | nPEP+n | | | | | | | |
| | | CPEP | | | | | | | |
| Mat3 | Schirmer | 21 | 435.8 | 643.8 | 1.86568 | 1.76542 | 1.53995 | 1.51294 | −.041 to |
| | | nPZPOm | | | | | | | +.041 |

PreGradOpT no then ne

| | | | | | | | | | |
|---|---|---|---|---|---|---|---|---|---|
| Mat2 | Schirmer | 15 | 435.8 | 643.8 | 1.52473 | 1.50305 | 1.72813 | 1.67885 | |
| | | nPEP+nCPEP | | | | | | | −.069 to |
| Mat3 | Schirmer | 25 nOPP | 435.8 | 643.8 | 1.54561 | 1.51594 | 1.85024 | 1.75086 | +.069 |
| Mat2 | EM | ZLl-2419 | 435.8 | 643.8 | 1.53075 | 1.50222 | 1.68559 | 1.64030 | |
| | Industries | | | | | | | | |
| Mat3 | Schirmer | 21 nPZPOm | 435.8 | 643.8 | 1.53995 | 1.51294 | 1.86568 | 1.76542 | −.067 to |
| | | | | | | | | | +.067 |

PreHalfGradOpT no then ne

| | | | | | | | | | |
|---|---|---|---|---|---|---|---|---|---|
| Mat2 | Schirmer | 15 | 435.8 | 643.8 | 1.52473 | 1.50305 | 1.72813 | 1.67885 | |
| | | nPEP+nCPEP | | | | | | | −.077 to |
| Mat3 | Schirmer | 25 nOPP | 435.8 | 643.8 | 1.54561 | 1.51594 | 1.85024 | 1.75086 | −.077 to |
| | | | | | | | | | +.077 |
| Mat2 | EM | ZLl-2419 | 435.8 | 643.8 | 1.53075 | 1.50222 | 1.68559 | 1.64030 | |
| | Industries | | | | | | | | −.073 to |
| Mat3 | Schirmer | 21 nPZPOm | 435.8 | 643.8 | 1.53995 | 1.51294 | 1.86568 | 1.76542 | +.073 |

Phoslo no then ne

| | | | | | | | | | |
|---|---|---|---|---|---|---|---|---|---|
| Mat2 | Schirmer | 15 | 435.8 | 643.8 | 1.52473 | 1.50305 | 1.72813 | 1.67885 | |
| | | nPEP+nCPEP | | | | | | | −.043 to |
| Mat3 | Schirmer | 25 nOPP | 435.8 | 643.8 | 1.54561 | 1.51594 | 1.85024 | 1.75086 | −.043 to |
| | | | | | | | | | +.043 |
| Mat2 | EM | ZLl-2419 | 435.8 | 643.8 | 1.53075 | 1.50222 | 1.68559 | 1.64030 | |
| | Industries | | | | | | | | −.041 to |
| Mat3 | Schirmer | 21 nPZPOm | 435.8 | 643.8 | 1.53995 | 1.51294 | 1.86568 | 1.76542 | +.041 |

FIG. 25 shows three GULI windows included with the PreGradOpt operating software of the first addressing embodiment. A “List” window displays the refractive indices for Mat2 and Mat3 in States 1 and 2 at different frequencies and/or at different temperatures. A “Parameters” window displays Incident Angles that are to be used, the Mat2 Offset and Mat3 Offset operating ranges, the Image Distance, the Object Distance, the Temperature and the Relative Tolerance (dispersion). The window labeled “PreGradOpT” displays the relative deflection angles as “FreEL” and “FrefH” which are then used to determine “Rel” (dispersion). The Table I logic describes light moving through the two materials when addressed by this embodiment.

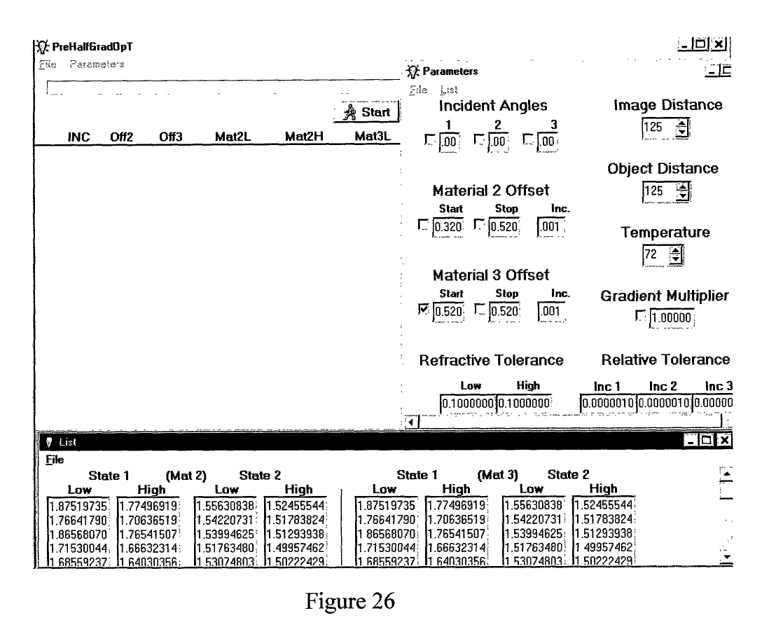

FIG. 26 includes three GUI windows included with the PreHalfGradOpt operating software. It incorporates the features described under FIG. 25. The Table IV logic describes light moving through the two materials when addressed by this embodiment.

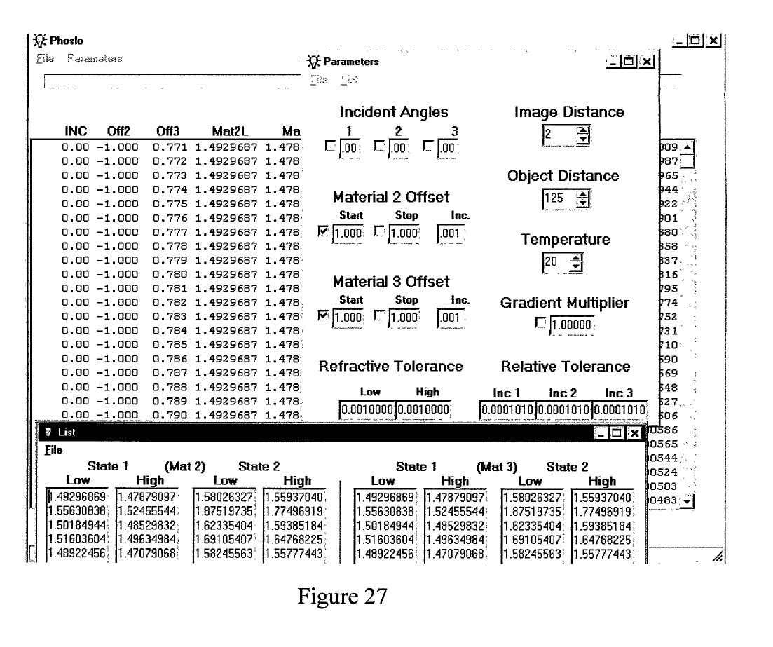

FIG. 27 includes three GUI windows included with the Phoslo operating software. It incorporates the features described under FIG. 25. The Table V logic describes light moving through the two materials when addressed by this embodiment.

Additional Embodiments.

The structures described herein are very useful in the embodiment of the variable view window. Said windows being mountable in a building, on an automobile, boat, aircraft or any other conveyance. Variable mirrors—The structures disclosed herein can be used to form variable mirrors when one of the prisms angles reaches the point of total internal reflection.

Computer Monitors and TV screens can be viewed from any angle using the variable structures disclosed herein.

The laser addressing means can also use mirrors to direct the laser beam.

Addressing means other than those presented here are possible.

The described embodiments use refraction arrays but diffraction arrays can be similarly addressed and used to achieve similar ends.

The preceding is not to be construed as any limitation on the claims and uses for the structures disclosed herein.

Previous Disclosures

Previous disclosures in the form of patent applications and provisional applications have been filed by the present inventor. They include the techniques for reducing the dispersion associated with refraction using a fluid with a refractive index to counteract the chromatic distortion effects of dispersion. Previous filings include the use of computer software and hardware to calculate dispersion, actuate surfaces, control temperature, and reduce dispersion. Such techniques as previously disclosed by the present applicant can also be used with the present structures disclosed herein but have not be rediscussed to avoid redundancy.

Advantages

Many advantages of the embodiments are present because the user can see many different views from any given vantage point which would otherwise not be possible. Firstly, high refraction is achievable. Secondly, dispersion can be reduced to a tolerance below 0.00001 radians across the visible spectrum. Thirdly, no physical movement is required (except with the addressing laser). With miniaturization, total thickness can be minimized. Fourthly, this structure is compatible with automobile characteristics, and can readily be mounted on any conveyance. Fifthly, for novelty, the window can be adjusted to alter the color separation caused by dispersion. For example, the user can maximize color separation to provide a uniquely distorted view of outside. Sixthly, the prism arrays can be formulated with the present invention to form letters on storefront windows which shoppers for instance can read. Said letters being reconfigurable nearly instantly.

Benefits of the Present Invention.

The invention disclosed herein is a new kind of lens, screen or window. Heretofore, viewing angles possible through a lens, screen or window were only adjustable by moving the viewer's viewing angle. If the viewer looked out these windows at a norm angle to the window, they would see an object at the norm angle to the window. The present invention enables a viewer to look through a prismatic window at a norm to the window yet to see objects located in any selected direction not necessarily at the norm angle to the window. Such a window may be used to create a completely new view in a room that may otherwise have an undesirable view. Moreover, under the present invention, a viewer may view at an infinite number of angles while looking from the perspective of a single angle. Under the present invention, a user may stay in one position and look in different directions through a window as desired. This is desirable within buildings to view sights otherwise not possible or practicable and within automobiles to eliminate blind spots. The alternate views made possible by the present invention are also of interest to the retail industry. The retail industry can display merchandise in new ways. Through a variable view window, shoppers can see merchandise within a window display from greater angles than are otherwise possible. Retail display cases and refrigerated display cases can also use the art disclosed herein to enable consumers to view products within from angles not otherwise possible.

Conclusion, Ramifications, and Scope

Thus the reader will see that the variable view window of this invention provides a highly functional and reliable means to alter the view provided through a window from any given vantage point. This is useful from aesthetic and functional perspectives.

While my above description describes many specifications, these should not be construed as limitations on the scope of the invention, but rather as an exemplification of one preferred embodiment thereof Many other variations are possible. . Window panes referred to herein can be manufactured with many materials, many electro-optic materials with refractive indices not included herewith can be used. Electrode configurations are manifold in the art, many of which can be used with the present invention. Matrix control and bus control techniques are well known in the art, many of which can be used herewith. Different gradient crystal alignments are achievable which can be used herewith.

Accordingly, the scope of the invention should be determined not by the embodiment(s) illustrated, but by the appended claims and their legal equivalents.

I claim:

1. An optical system adapted for selecting the resultant trajectory of an incident beam of electromagnetic energy comprising:
a) a first material with a variable refractive index;
b) a second material with a variable refractive index;
c) a computer in communication with at least one said material with a variable refractive index so as to send a signal to vary said material's affect on said resultant trajectory; and
d) wherein spectral dispersion of said beam caused by the first material is reduced by the second material.

2. The optical system described in 1, wherein said computer uses at least one said material's temperature as an input.

3. The optical system described in 1, wherein at least one said material's refractive properties are alterable in response to the alignment of an electric field.

4. The optical system described in 1, wherein at least one said material includes a gradient refractive index.

5. The optical system described in 1, further including an array of variable prisms in at least one said material.

6. The optical system described in 1, wherein the deflection achieved by at least one said material is variable as a function of an angle at which said material transitions from a first refractive state to a second refractive state.

7. The optical system described in 1, wherein at least one said material's refractive properties are alterable in response to the alignment of an beam of electromagnetic energy passing therethrough.

8. The optical system described in 1, wherein said computer receives information describing a user's position.

9. The optical system described in 1, wherein said computer receives information describing an object's position.
